(19) United States
(12) Patent Application Publication
(10) Pub. No.: US 2011/0112901 A1
(43) Pub. Date: May 12, 2011

(54) TRUST-BASED PERSONALIZED OFFER PORTAL

(76) Inventors: Lance Fried, Aventura, FL (US); Joseph Ketz, Atlanta, GA (US)

(21) Appl. No.: 12/772,894

(22) Filed: May 3, 2010

Related U.S. Application Data
(60) Provisional application No. 61/176,714, filed on May 8, 2009.

(51) Int. Cl. G06Q 30/00

(52) U.S. Cl. 705/14.49

(57) ABSTRACT

A portal system for secure, aggregated and centralized management of delivering various offers in accordance with specified customer preferences is contemplated. An offer configuration server permits the vendor to specify offers based on various factors such as volume, start time, expiration, and to specify the particular customer device to which the offers are delivered. Customers have associated receive settings that define the preferred frequency, nature of the offers, vendors, and demographic exposure. The offers are delivered to the customer in accordance with these settings.

### CROSS-REFERENCE TO RELATED APPLICATIONS

This application relates to and claims the benefit of U.S. Provisional Application No. 61/176,714 filed May 8, 2009 and entitled Trust-Based Personalized Offer Portal, the entire content of which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to telecommunications systems, and more particularly, to a trust-based personalized offer portal.

2. Related Art

Organizations both large and small collectively spend billions of dollars each year on advertising, brand recognition, and deal promotion. The typical metric for establishing rates for advertising are based on the number of impressions per one thousand views or impressions. This is manifest in the term cost per impression (CPM) or the cost per thousand views. There are many ways to calculate this CPM metric for traditional magazine and newspaper advertising as well as for modern electronic media such as web sites.

Various methods have been employed and organizations recruited to verify the claims of companies selling ads as to the actual impressions made in that particular medium. For example, in magazine advertising, BPA Worldwide is the organization most recognized for verifying the number of subscriptions that a magazine can claim.

Such verification is more difficult with Internet and the World Wide Web advertising modalities. For example, it is difficult to substantiate how qualified some “web hits” may be, and if, in fact, the visitors are human beings or automated web crawlers.

Particularly vexing to the buyers of traditional advertising is the amount of waste involved. For example, if an equivalent of $65 dollars is being paid per impression, and a million impressions are purchased, over fifteen thousand dollars has been spent. The problem for the advertising buyer is the fact that so few people actually see the ad and are “impressed upon.” It is therefore well understood that traditional advertising is highly wasteful.

With the rise of the Internet and non-traditional means of advertising such as bulk email, more problems exist. These problems deal with the overall cynicism of customers, many of whom wade through dozens, if not hundreds of unwanted solicitations each day. Add to this the myriad of pop-up advertisements and banner advertisements on web sites, and today's consumer is literally bombarded with offers all day long considering both newer and traditional forms of media.

These offers also create a state of general confusion and cynicism with any type of communication, legitimate or not, such that important communications such as email notices from banks, insurance companies and other vendors are viewed with suspicion. This distrust is compounded with illegal phishing and address spoofing schemes that get in the way of legitimate communications.

These issues force vendors to spend even more money on advertising and promotion, as well as to find new and different ways to reach consumers, both for promotional purposes, or in the basic day-to-day customer service context of providing billing information, or other legitimate, private communications. The fundamental problem is three-fold: first, most advertisements are not effective because they contain too much information to process, thereby creating an escalation of silly, provocative and seemingly irrelevant attempts to get attention. Second, there is the issue of trust, as most consumers distrust new-media advertisers because the common perception is that advertisers do not respect privacy or the overall preferences of the consumer. Third, legitimate, private communications intended for the user are often lumped-in to “junk” mail and ignored.

These three problems add up to a great deal of apprehension and frustration on the side of the consumer, and make it nearly impossible for advertisers to appeal to them. Vendors must differentiate from other competitors and attempt to communicate privately in any way they can, while appeasing cynical consumers who are generally distrusting of advertisers. Accordingly, there is a need in the art for resolving these novel trust and privacy issues in the context of the modern day media.

### BRIEF SUMMARY

In accordance with various embodiments of the present invention, there is contemplated a trust-based personalized offer portal for delivering secure, aggregated and centralized management of personalized advertisements, offers, reverse auctions and coupon redemptions. The customers may explicitly and selectively allow preferred vendors to tender commercial offers based on specified preferences. The trust-based personalized offer portal is understood to create a closed community of traders where the operator creates a privacy covenant between the vendors and the customers which can only be broken by the customer.

In another aspect, there is an offer configuration server to which the vendors have access. Through the offer configuration server, the vendor can upload specific text, photos, video and other media associated with a particular offer campaign that will not be available to the general public. This is understood to create a “private sale” mechanism for the vendor to tender offers on a highly qualified basis.

There is also contemplated a method for vendor submission of time-varying parameters associated with offer campaigns. Vendors can stipulate the frequency with which a certain offer can be tendered, the volume of individual offers over that period of time and the offer expiration date. This method for vendors to submit time-varying parameters as they relate to specific offer campaigns leverage supply and demand to promote special promotions for limited quantities or fire sales Likewise, based upon time-varying parameters to vendors can limit access to offers the vendor discovers are not profitable.

The vendor may be provided with a method for throttling the discrete number (volume) of personalized offers that will be made. Accordingly, a budget for offer campaigns can be developed and enforced even though time-varying media parameters may stretch the offer campaign out for many weeks or months if the customer input collectively limits the number of offers allowed during that time frame.

Additionally, the vendor may be able to stipulate various demographic parameters in the creation of an offer campaign. These demographic parameters act as a means to further restrict or qualify the offer campaign. For example, demographic parameters may include but are not limited to: a) the age range of the intended audience; b) the frequency of logins to the trust-based personalized offer portal; c) the preferred terminal (user) device of the customers; d) the preference or non-preference for certain types of products; e) the preference of time frames and frequencies for offers, f) live in a certain area, and so on. By using these demographic parameters, a vendor can program an offer campaign only to reach customers meeting these criteria, as offers are only paid for and sent to a pre-qualified audience.

The trust-based personalized offer portal may include an “offer slot” advertising metric. Because the offer slot is tied to a centralized system and has access to ongoing demographic information of the customer base, it is therefore possible to dynamically establish a price therefor. An offer slot is a unique, personalized offer that will be tendered to a customer who has authorized offers from that vendor. The number of Offer Slots available may not exceed the sum of all allowed offers by the collective customers served during any particular time period. This “throttling” of the offers allowed for sale is based on stored parameters of customer preferences and demographics.

A reporting and analysis capability can automatically collect the appropriate “throttling” data from the database and render this information into special reports and pricing models available to the administrator and also to authorized vendors. Once this data is collected, based on the peculiar inputs by the vendor during a session, the rates for the offer campaign may be calculated and presented to the vendor. The establishment of rates may be tied to the perceived premium for limited offer slots and the availability of certain time frames and frequencies allowed collectively by the customers. The rates for advertising (that is allowing the offers to be posted) may be dynamic. Accordingly, the pricing of offer slots may be tied specifically to offer campaign performance data that may establish a sense of “fair and equitable” pricing for the same.

The offer configuration server, or the mechanism with which vendors create, edit and launch offer campaigns, may be shared in a network arrangement or may be dedicated on a per-vendor basis as in Customer Premises Equipment (CPE). This may be advantageous for vendors who have peculiar security concerns or policies.

Customers may also have access to the trust-based personalized offer portal and can create a persona corral. These personas will contain customer-stipulated preferences for commercial offers. Such personas can be created, edited and stored based on a personalized offer enrollment system. The customer is able to choose specific parameters for his presence and preferences in the system including but not limited to preferred providers or vendors, time of day preferences for commercial offers, product preferences, preferences on demographic exposure, and the frequency of commercial offers allowed.

In another aspect of the invention, offers may be predetermined and tendered to a plurality of customers at the same time by the vendor, or alternatively, offers can be triggered by the customer in the form of an automated reverse auction. For example, in creating a persona corral, a customer may stipulate non-predetermined, non-generic criteria in order to trigger a customized reverse auction. Vendors who are not otherwise authorized to use the trust-based personalized offer portal can engage in commerce.

Where a plurality of vendors may be engaged simultaneously by using the trust-based personalized offer portal to create ad -hoc, one-to-one campaigns or responses based on an ad-hoc request from a Customer can be triggered by a reverse auction. Thus, the offers in response to a reverse auction may be formatted in the same, familiar, model as per the offer inbox, with which the customer may have a level of comfort. The offer inbox mechanism provides a means for customers to store and retrieve offers that have not yet expired, such that the customer can compare several offers on a similar type of product from preferred vendors over time.

In accordance with another aspect of the present invention, there is provided a mechanism to connect vendors and customers together via both real time and non-real time media. Delivery of allowed offers via personalized offer inbox mechanism is portable and useable on a plurality of devices including, web browsers, smart phones, telephones, VoIP telephones, and multimedia/TV set top boxes. Furthermore, this personalized offer inbox mechanism provides a security and privacy because in the use of the trust-based personalized offer portal, only authorized offers will arrive in the personalized offer inbox. This closed system filters out any unauthorized solicitations. The trust-based personalized offer portal also allows one-to-one real time and non-real time communications such as chat, email, phone calls and two-way video. Therefore, a customer who allows such communications may receive follow-up requests involving a possible purchase or customer service call.

In another aspect, offer script instructions from the offer configuration server may be implemented by the practitioner in a hybrid fashion. The vendor can thus create offer campaigns that take advantage of terminal device preferences stipulated by the customer, and customers will likely prefer vendors connecting to them via the preferred modality.

The present invention also contemplates the offer configuration server and associated delivery mechanisms provide a way to bypass email, SMS and other non-secure messaging channels. Thus, a private and secure messaging channel for the delivery of private communications of any kind is provided. Enterprises and even individual senders of private communications can bypass illegal phishing and address spoofing schemes by using the trust-based personalized offer portal as a secure message conveyance system with the ability to deliver messages to a plurality of user devices including, but not limited to screen-based phones, SmartPhones, Cell Phones, web portals, in-car navigation systems and IPTV set top boxes, among others.

### BRIEF DESCRIPTION OF THE DRAWINGS

These and other features and advantages of the various embodiments disclosed herein will be better understood with respect to the following description and drawings, in which:

FIG. 1 is a block diagram illustrating a trust-based personalized offer portal, which can be deployed in a variety of environments including IPTV set top, telephone, mobile, cable TV, satellite and Internet deployment;

FIG. 2 is a detailed block diagram of the trust-based personalized offer portal architecture from a communications and control perspective;

FIG. 3 is a block diagram showing a high-level view of the application services and special resources architecture;

FIG. 4 is a block diagram of the structure of the trust-based personalized offer portal database;

FIG. 5 is a block diagram of individual application servers and special resources inside of the trust-based personalized offer portal;

FIG. 6 is a block diagram of the architecture for a web browser user device;

FIG. 7 is a block diagram of the architecture for a smart phone user device;

FIG. 8 is a block diagram of the architecture for a telephone user device;

FIG. 9 is a block diagram of the architecture for a multimedia—TV set top box user device;

FIG. 10 is a block diagram illustrating the architecture for a common user interface aggregator matrix;

FIG. 11 is a block diagram describing the schema for multi-phased biometric security;

FIG. 12 is a flowchart illustrating the creation of a persona corral;

FIG. 13 is a flowchart illustrating the creation of a persona using a telephone or speech device;

FIG. 14 is a flowchart of a security enrollment routine for an embedded speech device;

FIG. 15 is a flowchart of a security enrollment routine for a telephone-based device;

FIG. 16 is a flowchart of a two-phased security routine for the embedded speech device;

FIG. 17 is a flowchart of a two-phased security routine for the telephone-based device; and

FIG. 18 is a flowchart describing the logic of configuring an offer by the vendor.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as top and bottom, first and second, and the like are used solely to distinguish one entity from another without necessarily requiring or implying any actual such relationship or order between such entities.

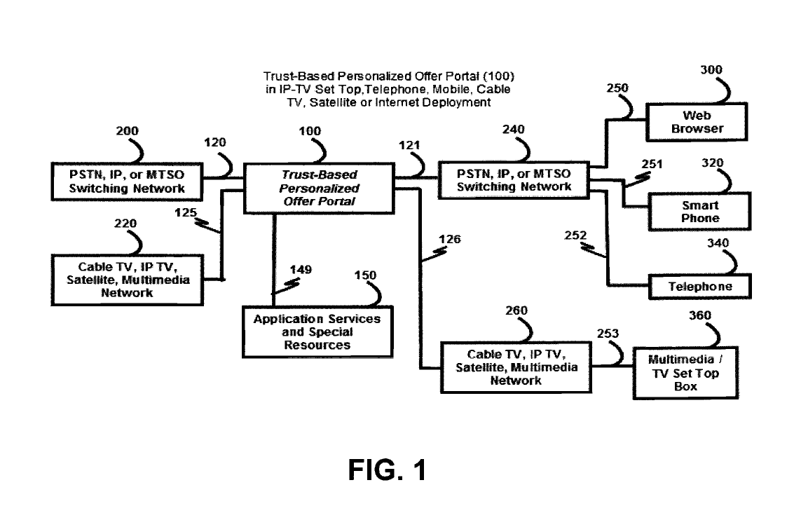

FIG. 1 shows the one example of the placement of trust-based personalized offer portal 100. The trust-based personalized offer portal 100 of this embodiment has connections to a plurality of telecommunications and computing networks, including, but not limited to the public switched telephone network (PSTN), IP-based networks such as the Internet, and the 3G mobile cellular network. The trust-based personalized offer portal 100 of this embodiment also has connections to other networks, including, but not limited to the Cable TV, IP TV, satellite and other multimedia, high-speed networks.

A first type of telecommunications and computing network represented in FIG. 1 is PSTN, IP, or MTSO switching networks 200. This network represents the vendor (advertiser) side of the deployment, where the network is arranged to provide trust-based personalized offer portal 100 access to vendors, who may operate their own advertising-oriented web sites and social networking sites. In addition, another network depicted called PSTN, IP, or MTSO switching networks 240 represents the customer side of the deployment, where terminal devices such as web browsers, smart phones, and telephones are used by customers to access the trust-based personalized offer portal 100.

A second type of telecommunications and computing network represented in FIG. 1 is a Cable TV, IP TV, satellite, multimedia networks 220. This network represents an alternate vendor (advertiser) side of the deployment, where the network is arranged to provide the trust-based personalized offer portal 100 access to vendors, who may operate their own advertising-oriented web sites and social networking sites via Cable TV, IP TV, satellite, or multimedia networks. In addition, another network depicted called Cable TV, IP TV, satellite, multimedia networks 260 represents the customer side of the deployment, where terminal (user) devices such as multimedia and TV set-top boxes and related controllers are used by customers to access the trust-based personalized offer portal 100.

The telecommunications and computing networks depicted in FIG. 1 may use a variety of commonly deployed transmission schemes and protocols. These networks 200, 220, 240, 260 can be used both for command and control and for the carriage of content. Command and control are signals that allow for the general collaboration between devices, where as content signals carry media such as telephone calls, video, email, chats, and SMS messaging. Command and control and content signaling protocols and standards used on these networks include but are not limited to: transmission control protocol (TCP), Internet protocol (IP), hypertext transfer protocol (HTTP), file transfer protocol (FTP), real-time transport protocol (RTP), user datagram protocol (UDP), session initiation protocol (SIP), simple mail transfer protocol (SMTP), post office protocol 3 (POP3), internet message access protocol (IMAP4), pulse code modulation/time division multiplexing in T-1 signaling (PCM/TDM), primary rate and integrated services digital network telephone signaling (PRI), 10 gigabit Ethernet, 3G networking, and IPTV.

FIG. 1 also shows one placement of the trust-based personalized offer portal 100 and its relationship with the application services and special resources 150 array, representing a network of resources, databases and server applications that are part of the overall trust-based personalized offer portal architecture. The trust-based personalized offer portal 100 and the application services and special resources 150 array are connected by a telecommunications link 149. Through the telecommunications link 149, the trust-based personalized offer portal has access to its own application services and special resources. These application services and special resources make up the core of the trust-based personalized offer portal 100. Through these telecommunications and computing networks, the trust-based personalized offer portal also has access to all four network types 200, 220, 240, 260 via access links 120, 125, 121 and 126, respectively.

FIG. 1 also shows an embodiment of telecommunications and computing network called PSTN, IP, or MTSO switching networks 240 and its connections to terminal (user) devices including, but not limited to web browsers 300, smart phones 320, and telephones 340. This arrangement depicts the customer side of the trust-based personalized offer portal 100 deployment. These devices are able to communicate to the trust-based personalized offer portal 100, via the networks 240 using the telecommunications links 250, 251, and 252, respectively.

FIG. 1 also shows the an embodiment of telecommunications and computing network called Cable TV, IP TV, satellite, multimedia network 260 and its connections to terminal (user) devices including, but not limited to multimedia and television set-top boxes 360. This arrangement depicts another aspect of the customer side of the trust-based personalized offer portal deployment. These devices are able to communicate to the trust-based personalized offer portal 100, via the networks 260 using the telecommunications link 253.

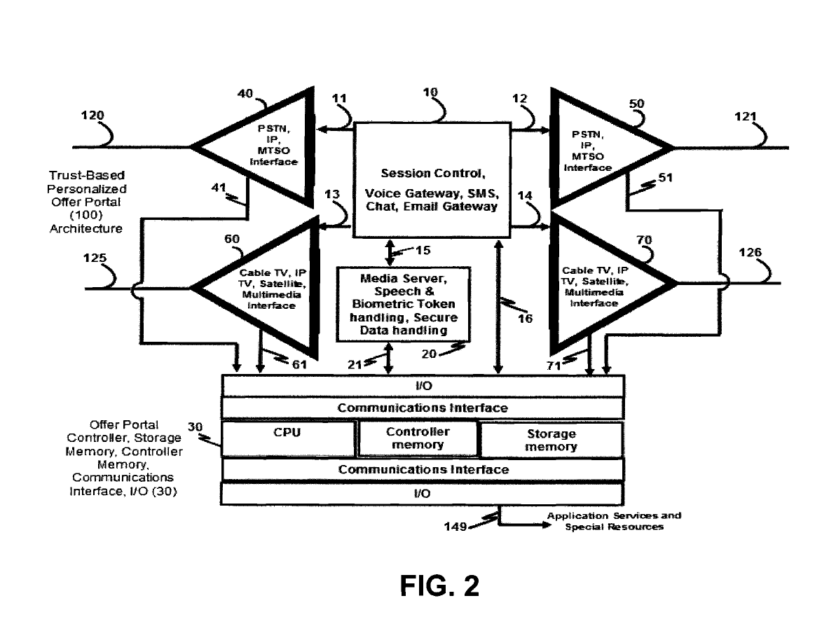

FIG. 2 shows an embodiment of the communications and control architecture aspect of the trust-based personalized offer portal 100. The session control, voice gateway, SMS, chat, email gateway 10 is depicted as a centralized control device for multiple network signaling interfaces. The session control, voice gateway, SMS, chat, email gateway 10 is connected to these network signaling interfaces by way of a communications path and driver depicted in FIG. 2 as access paths 11, 12, 13 and 14. Session control, voice gateway, SMS, chat, email gateway 10 uses the network signaling interfaces for controlling telephone calls and other communications between terminal (user) devices (on behalf of customers) and the vendors (advertisers). This control of media transmissions is not limited to telephone calls. In a one embodiment, the session control, voice gateway, SMS, chat, email gateway 10 will also control the transmission of other communications including, but not limited to chats, SMS and email. A processor is connected to the network signaling interfaces via session control, voice gateway, SMS, chat, email gateway 10 and the offer portal controller, storage memory, controller memory, communications interface, I/O 30 —(offer portal controller 30). The network signaling interfaces are controlled by the session control, voice gateway, SMS, chat, email gateway 10.

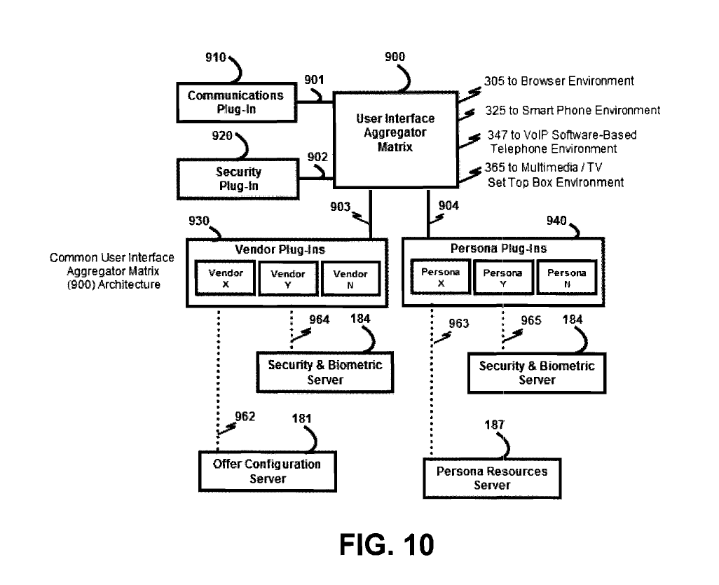

In another embodiment of the invention, users may respond to an offer provided by the portal on behalf of a vendor (advertiser) by clicking on a button provided by the user interface aggregator matrix 900, as depicted in FIG. 10, in order to trigger a phone call to the vendor (advertiser) in a semi-automated response to an offer. Likewise, this use of a button may be augmented by a speech command uttered by the customer to trigger a similar communication to the vendor. The practitioner will find many standard means to affect a communication between these parties that can manifest in emails, chats or other communications by using the media manipulation and network interfaces and protocols available in the session control, voice gateway, SMS, chat, email gateway 10.

FIG. 2 also shows one placement of a media server, speech and biometric token handling, secure data handling module 20 (media server 20). The media server 20 is a connected to the session control, voice gateway, SMS, chat, email gateway 10 with access point 15. This access point allows these two elements to work collaboratively. Media servers are also commonly available hardware apparatus, built primarily with off-the-shelf microprocessors and related gear. Vendors such as Dialogic with their Contata (nee Brooktrout) media server and RadiSys Convedia CMS-3000 media server are commonly available. For speech recognition, and biometric security applications, special media servers can be equipped with media resource control protocol (MRCP). Technology to control media as with MRCP is commonly available from vendors such as Aumtech and Voxeo. Biometric technology in the form of speaker verification is commonly available from vendors such as the IBM Conversational Biometrics Group or Valid Voice of Melbourne.

FIG. 2 depicts another embodiment of the invention, showing how both the media server 20 and the session control, voice gateway, SMS, chat, email gateway 10 are not only connected together, but also may both be connected to the offer portal controller 30 via access points 21 and 16 respectively. The offer portal controller 30 operates as an outboard software state controller. The offer portal controller 30 is comprised of a standard microcomputer apparatus which includes but is not limited to multiple I/O (input output) devices, a communications interface, storage memory, and a CPU. Such standard microcomputer apparatuses are commonly available from vendors such as HP or Sun Microsystems.

The offer portal controller 30 may receive status messages from the media server 20 and the session control, voice gateway, SMS, chat, email gateway 10. The messages may be derived from media server 20 and the session control, voice gateway, SMS, chat, email gateway 10 based upon the detection of events and processes on the network signaling interfaces.

For example, in one embodiment, the network signaling interfaces may both receive commands to execute on or send messages alerting the status of telephone lines, email transmissions and chat signals. The offer portal controller 30 may send network routing and/or origination information to the media server 20 and the session control, voice gateway, SMS, chat, email gateway 10 to facilitate the set-up and tear-down of various transactions. The offer portal controller 30 is afforded the intelligence it needs to make these commands and process these status messages owing to the services of the applications services and special resources 15, which the offer portal controller 30 is connected to over access point 149.

In another embodiment of the invention, multiple trust-based personalized offer portals 100 and associated offer portal controllers 30 would be clustered in an N+1 resilient arrangement. Multiple access points or a common TCP/IP communications bus would be used to connect an array of these servers together to achieve higher density and a modicum of service resiliency. Such an arrangement would call for the use of commonly available load balancers, such as content switches and load balancers from Big IP or Cisco.

In yet another embodiment the trust-based personalized offer portal is designed for interfacing with a variety of telecommunications and computing networks under software state control. These are the same networks as described in FIG. 1. A standard method for accessing networks is a network signaling interface. Such devices are commonly available from Cisco, Dialogic, and AudioCodes, for example.

One embodiment of a network signaling interface is represented in FIG. 2 as PSTN, IP, MTSO interface 40. This network signaling interface is connected to the appropriate network via a telecommunications link 120 which in turn connects the trust-based personalized offer portal to the PSTN, IP or MTSO switching network 200 as shown in FIG. 1. PSTN, IP, MTSO interface 40 is also connected to the offer portal controller 30 via access point 41. This PSTN, IP, MTSO interface 40 represents access to the network on the vendor (advertiser) side of the deployment, where the network is arranged to host services and capabilities of vendors' contact centers, customer service web sites and social networking sites.

FIG. 2 depicts another embodiment of a network signaling interface represented as PSTN, IP, MTSO interface 50. This network signaling interface is connected to the appropriate network via a telecommunications link 121 which in turn connects the trust-based personalized offer portal to the PSTN, IP or MTSO switching network 240 as shown in FIG. 1. PSTN, IP, MTSO interface 50 is also connected to the offer portal controller 30 via access point 51. This PSTN, IP, MTSO interface 50 depicts the customer side of the trust-based personalized offer portal deployment as it relates to customer terminal (user) devices such as web browsers, smart phones and telephones.

A second embodiment of a network signaling interface is represented in FIG. 2 as Cable TV, IP TV, satellite, multimedia interface 60. This network signaling interface is connected to the appropriate network via a telecommunications link 125 which in turn connects the trust-based personalized offer portal to the cable TC, IP TV, satellite, multimedia network 220 as shown in FIG. 1. Cable TV, IP TV, satellite, multimedia interface 60 is also connected to the offer portal controller 30 via access point 61. This Cable TC, IP TV, satellite, multimedia interface 60 represents access to the network on the vendor (advertiser) side of the deployment, where the network is arranged to host services and capabilities of vendors' contact centers, customer service web sites and social networking sites.

FIG. 2 depicts another embodiment of a network signaling interface represented Cable TV, IP TV, satellite, multimedia interface 70. This network signaling interface is connected to the appropriate network via a telecommunications link 126 which in turn connects the trust-based personalized offer portal to the Cable TV, IP TV, satellite, multimedia network 260 as shown in FIG. 1. Cable TV, IP TV, satellite, multimedia interface 70 is also connected to the offer portal controller 30 via access point 71. This Cable TV, IP TV, satellite, multimedia interface 70 depicts the customer side of the trust-based personalized offer portal deployment as it relates to a customer's terminal (user) device such as a multimedia or TV set-top box.

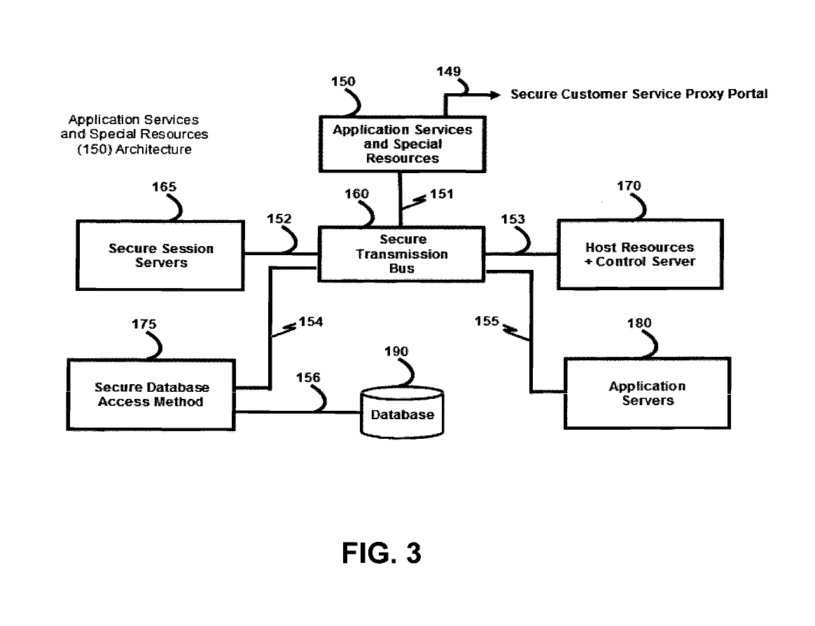

In this embodiment, the offer portal controller 30 receives the routing and media type information from the processor and accesses various databases to ascertain the proper routing for transactions that are related to vendors' offers. The offer portal controller 30 uses retrieval triggers in the database via a secure database access method 175 (see FIG. 3). Here, the database contains the stored vendor and offer scripts which include telephone routing and destination information so the trust-based personalized offer portal 100 may facilitate real time or non-real time communications between vendors and customers.

In some embodiments, the offer portal controller 30 will also control (along with the secure session servers 165 as shown in FIG. 3) access to transactions via the validation of a user session token. Such token will be generated for each session and triggered only by a successful biometric (spoken by the user) challenge. These biometric challenges may be employed for both vendors who access the system to configure offers and also customers who access the system to review offers.

FIG. 3 is a block diagram of showing a high-level view of the application services and special resources architecture. In one embodiment of the invention, the practitioner will deploy a distributed, network based architecture with the servers, processes and databases arranged around a secure transmission bus. In this aspect of the invention, as depicted in FIG. 3, the application services and special resources 150 gateway entity acts as a gateway for special services to the trust-based personalized offer portal 100. Here, a practitioner skilled in the art of local networking may deploy a commercially available communications bus, such as the information bus (TIB) from TIBCO Software Inc. of Palo Alto, Calif., which is depicted in FIG. 3 as secure transmission bus 160.

FIG. 3 depicts another embodiment of the invention. It shows how the secure transmission bus 160 may be connected to other entities in the architecture via access points. At access point 151 the bus 160 is connected to the application services and special resources gateway entity 150. At access point 152 the bus 160 is connected to the secure session servers 165 environment. At access point 153 the bus 160 is connected to the host resources and control server. At access point 154 the bus 160 is connected to the Secure Database Access Method 175 which is in turn connected to the actual database over access point 156. At access point 155 the bus 160 is connected to the application servers 180 environment.

In one embodiment of the invention, first arranged around the secure transmission bus 160 at the twelve o'clock position is the application services and special resources 150 gateway entity. In one embodiment of the invention, the practitioner will deploy a commonly available store and forward schema on this entity, such as is described in Sun Microsystems' J2EE container and similar web server software arrangements for common mailboxes and communications routines. Such routines are available on Apache, Sun and Microsoft IIS servers, for example.

One embodiment of the invention is depicted in FIG. 3, the application services and special resources 150 gateway entity acts as a consolidation and access point between other special services and the trust-based personalized offer portal 100. The communications between these server functions can be achieved via the access point 149 where commonly available protocols such as FTP, HTTPS and HTTP 1.1 for persistent connections may be utilized. A so-called software oriented architecture using SOAP or text over HTTP messaging can be used as a means to abstract direct database contact with servers outside of the application services and special resources environment. This is not to limit the means with which secure communications may be encrypted or transferred both inside and outside the application services and special resources environment. Various proprietary transmission and encryption schemes can be utilized.

In another embodiment, arranged around the secure transmission bus 160 is the host resources and control server 170. One purpose of the host resources and control server 170 is to maintain a working list of associated programs and their execution parameters and the location of those programs as they relate to physical resources.

In yet another embodiment, there is provided a secure database access method 175. One purpose of the secure database access method 175 is to ensure the integrity of private, sensitive or financial data and to make sure such data is not accessed by unauthorized programs. The secure database access method 175 may require an encrypted token for each secure data access. Such encrypted token may only be generated and authorized after a secure, biometric-based session verification with users. The actual database 190 server holds a plurality of database tables, each associated with application servers and secure data that must be stored and accessed to allow the trust-based personalized offer portal to operate.

In one embodiment, a secure session servers 165 is provided. one purpose of the secure session servers 165 is to ensure the integrity of each communication session with each user. Session integrity deals with the issues of persistence and failover. In one embodiment of the invention, the practitioner may deploy HTTP 1.1 or other persistent connections that work in tandem with web server clustering and load balancers in order to ensure the integrity of each transmission.

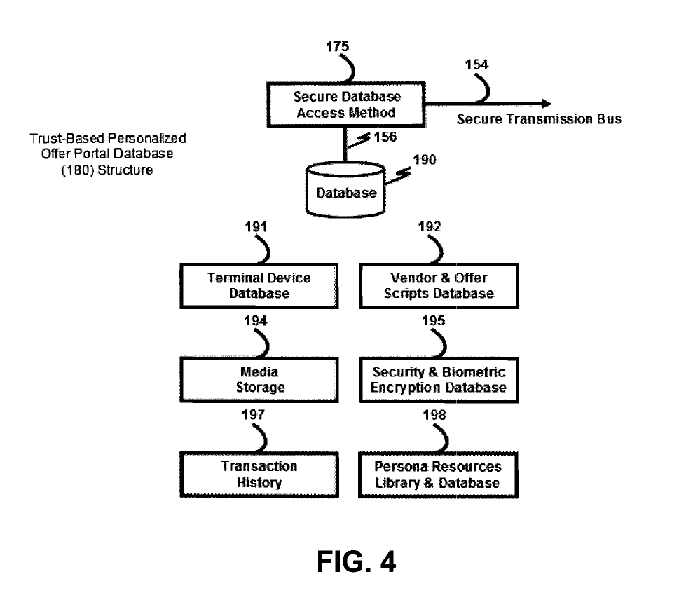

FIG. 4 illustrates one embodiment of the structure of the trust-based personalized offer portal database, referred to as the trust-based personalized offer portal database 180 structure. An access point 154 may connect the secure database access method 175, described above with reference to FIG. 3, to the secure transmission bus. The database access method 175 is also connected to the database 190.

The trust-based personalized offer portal 100 may utilize not only an array of gateways and application servers, but also a database. Database technology is commonly available in the public domain and commercially from vendors such as Microsoft and Oracle. FIG. 4 shows a plurality of databases that can be used collectively in a one embodiment of this invention. There is no limitation on the combination or distribution of these databases. In one aspect of the invention, the data may be available in one or only a few database tables. In another aspect of the invention, the data may be distributed in separate databases and database tables as is depicted in FIG. 4. The practitioner will decide if the concepts associated with each part of the drawing may be optimized by combination or distribution of the same.

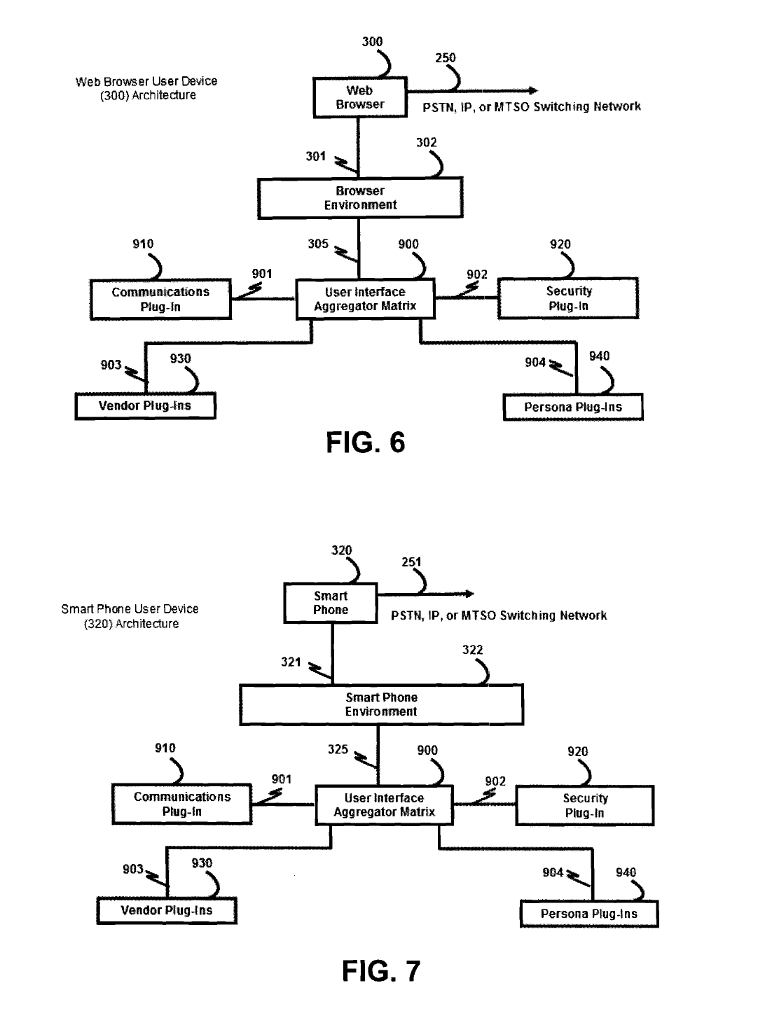

FIG. 4 shows an embodiment of the terminal device database 191. This table or collection of tables is used to store crucial information dealing with a plurality of user devices associated with the use of the trust-based personalized offer portal. As depicted in FIG. 1, these devices may be, but are not limited to: web browser 300, smart phone 320, telephone 340, and multimedia/TV set-top box 360. The terminal device protocol server 189 may receive commands from the secure session servers 165 as depicted in FIG. 6. These commands can be acted upon, in part, based upon data that the terminal device protocol server 189 relies on and which is stored in the terminal device database 191. The terminal device database 191 may include information on each device and can include, but not be limited to the following: a) a profile for each registered device which identifies a unique telephone number or other address that makes the device addressable by the application; b) a profile for each device which identifies the communication protocol associated with the device. Such protocols may be but are not limited to SIP, 3G, PSTN, or IP; c) a profile for each device that identifies the order of preference for its use by each user of the application; d) a profile for each device that identifies the preference for its use based on the availability of other, alternate devices associated with the user of the application; e) a profile for each device that links its accessibility to a security token and session token for its authorized use; and f) any attributes which distinguish a specific device as to suitability for direct use by users of the application via the trust-based personalized offer portal. Such devices will be employed by both vendors (advertisers) of the system and customers of the system.

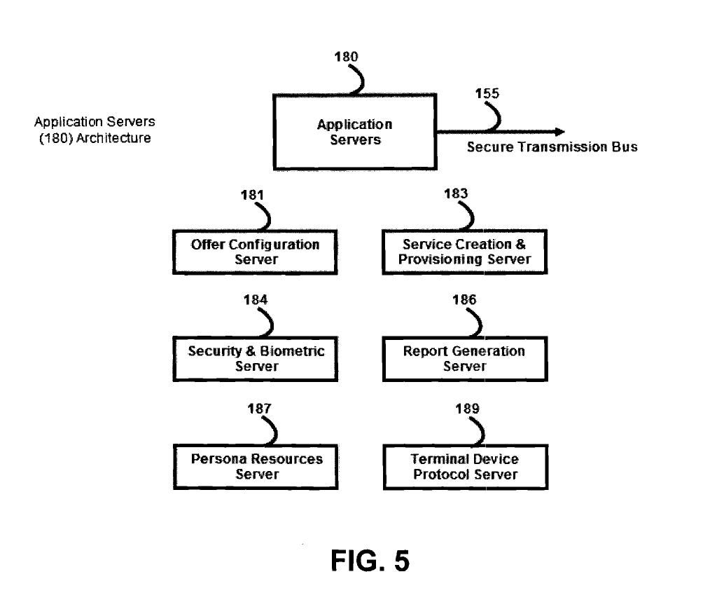

The block diagram of FIG. 4 also shows an embodiment of the vendor and offer scripts database 192. This table or collection of tables is used to store crucial information dealing with a plurality of automated, robotic routines that will run as commands associated with the use of the offer configuration server 181. As depicted in FIG. 5, the offer configuration server 181 may be deployed in a shared service topology. In another aspect of the invention, the offer configuration server 181 may be deployed in a dedicated service topology (i.e. one for each vendor on the vendor's site). Such a dedicated deployment of the offer configuration server 181 on vendors' respective sites can be achieved via a remote connection to the secure transmission bus 160. In another aspect of the invention, an alternate to a remote connection to the secure transmission bus may be secure access via a telecommunication method serviced by the session control, voice gateway, SMS, chat, email gateway 10. Such methods as text over HTTP, or SOAP will be well known by the practitioner as an alternative to a remote secure transmission bus 160 link.

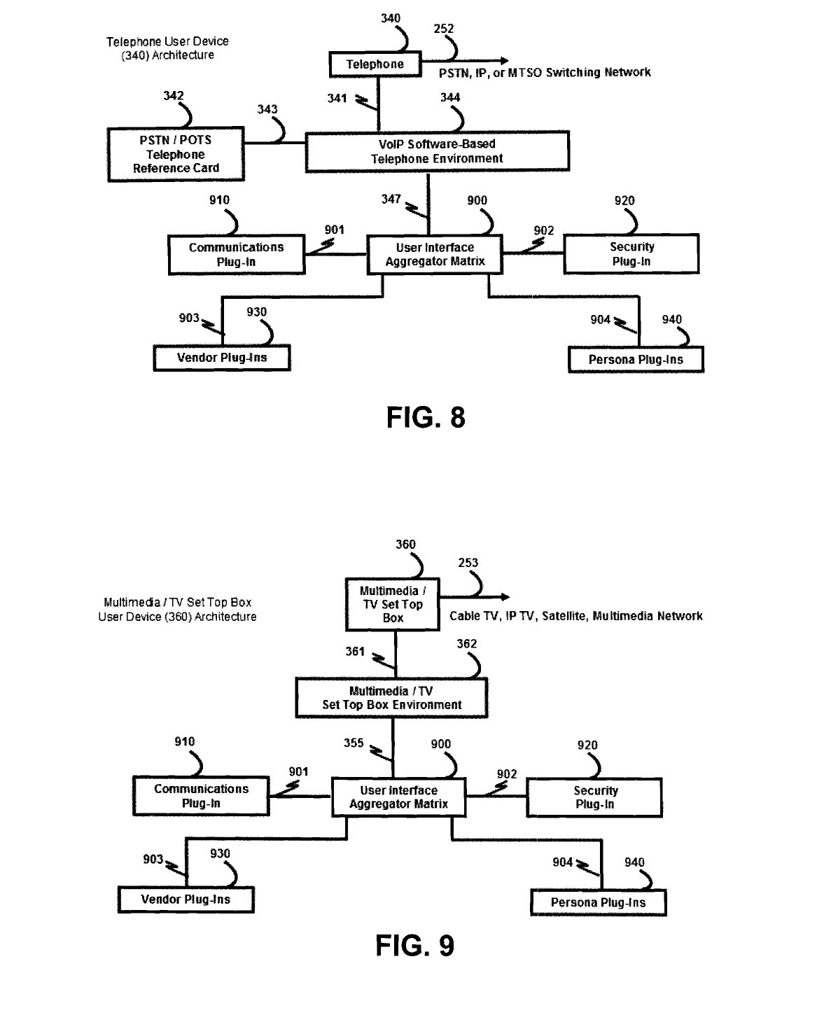

In one embodiment of the invention, the offer configuration server 181 may receive commands from the offer configuration server 181 as depicted in FIG. 8, which relies in part on data stored in the vendor and offer scripts database 192. The nature of these commands deal with what scripts must be loaded into memory and executed upon by the offer configuration server 181. The offer configuration server 181 may also receive commands from the secure session servers 165 as depicted in FIG. 6. The nature of these commands deal with the control and security of the actual sessions in which the scripts will be executed and the offers transmitted.

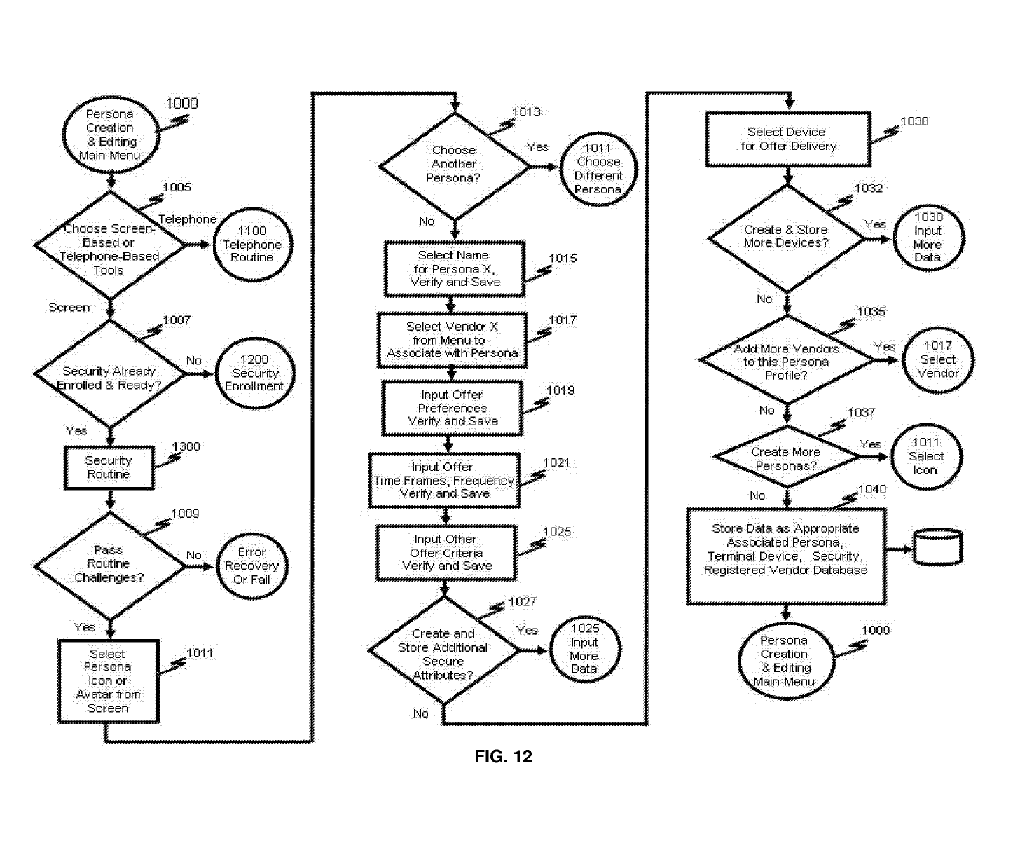

The vendor and offer scripts database 192 may include information on each offer script for each vendor and may include, but not be limited to the following: a) a template for a “verbal” interactive voice response (IVR) system delivery option of the offer, which can be used as basis for any offer script; b) a table or collection of tables which stores data on each offer script; c) a template for each commonly used and/or commercially available vendor web-based system which can be used as basis for submitting a “visual” offer script; d) a table or collection of tables which stores data on each vendor web-based offer script; e) a template for a native trust based personalized offer portal delivery to any of the user devices described with reference to FIG. 6, FIG. 7, FIG. 8, or FIG. 9 (including but not limited to web browsers, smart phones, telephones, and multimedia—TV Set-top boxes); f) a table or collection of tables which stores data on each native trust based personalized offer portal delivery to any of the user devices; g) a profile for each offer configuration server 181 that identifies what customer persona profiles are associated with the user of the application as it relates to the vendor and product preferences (as depicted in FIG. 12); h) a profile for each offer configuration server 181 that links its accessibility to a security token and session token for its authorized use; and i) any attributes which distinguish a specific offer configuration server 181 for direct use by users of the application via the trust-based personalized offer portal.

As shown in FIG. 4, there is also a means to provide for media storage 194. This may be a table or collection of tables is used to store crucial information dealing with the location and type of media being stored by the trust-based personalized offer portal. In one embodiment of the invention, the media storage 194 database tables and records will act as a pointer to BLOBs (binary large objects) which are in turn stored in the file system of the host computer in which the database resides. Such BLOBs may be stored in a separate location, in a separate host computer that the database can nonetheless point to so the application servers 180 as shown in FIG. 5 may have access to the media. Access to such media is facilitated by use of common protocols such as, but not limited to Multipurpose Internet Mail Extensions (MIME); Post Office Protocol 3 (POP3); simple mail transfer protocol (SMTP); Transmission Control Protocol/Internet Protocol (TCP/IP); file transfer protocol; and Internet message access protocol (IMAP4).

In one embodiment, the services of media storage 194 may be called upon via the secure database access method 175 by certain trust-based personalized offer portal entities. The offer configuration server 181 may send a command to the media storage entity to download and use media such as speech files for the offer configuration server 181 to use in its offer scripts with a particular speech or IVR function for “verbal” offers. In another aspect of the invention, the offer configuration server 181 may send a command to the media storage entity to download and use media such as chat scripts for the offer configuration server 181 to use in a chat dialog between vendors and customers as a customer-initiated follow-up to an offer. A variety of media may be stored in the media storage 194 in order to allow various trust-based personalized offer portal entities to take advantage of automation schema using stored and reusable media.

In another aspect of the invention, the services of the media storage 194 will be called upon via the secured database access method 175 by the security and biometric server 184 as depicted in FIG. 5. The security and biometric server 184 may use the media storage 194 to store and access encrypted biometric speech samples, prompts, or other media that may require encryption or association with security keys. In another aspect of the invention, the services of the media storage 194 will be called upon via the secured database access method 175 by the persona resources server 187 as depicted in FIG. 5. The persona resources server 187 may use the media storage 194 to store and access media associated with persona icons or avatars. In addition, the persona resources server 187 may use the media storage 194 to store and access media such as logos, identifiers, photos, or other media that may be associated with the common user interface aggregator matrix 900. In another aspect of the invention, vendors will be able to upload GIF, JPG, or video files associated with specific offers, which will be stored in the media storage 194 and then transmitted along with the offers to customers. The media storage 194 can be called upon other servers and shall not be limited to servers contemplated in FIG. 8.

FIG. 4 also depicts an embodiment of the invention where a means to provide for the security and biometric encryption database 195 is shown. This database uses a table or collection of tables to store crucial information dealing with but not limited to security routines, encryption applications, passwords, encryption keys, personal identification numbers, credit card numbers, PIN codes and other relevant data that would reasonably be expected to be part of a secure customer service or transaction processing scenario. Such scenarios being facilitated in part by the use of the trust-based personalized offer portal.

FIG. 4 also shows an embodiment of the transaction history database 197. This table or collection of tables is used to store crucial information dealing with specific events, such as system or interoperability events, and also transaction-oriented events, such as events associated with specific customer-specific phone calls, IP TV media transmissions, SMS transmissions, and chats between vendors and customers. Such transactions is not intended to be limited to native transactions that begin and end in the trust-based personalized offer portal environment, but may extend to other transactions that begin in other systems and end in other systems, but are nonetheless carried in part by the trust-based personalized offer portal. The transaction history database 197 will store relevant and useful data dealing with events, offers and transactions. data to be stored will include but not be limited to: a) an identifier of the originating system of the event; b) identifiers dealing with systems a transaction may be handed off to or conference with; c) a time stamp of the beginning and end of the transaction; d) the type of media employed in the transaction; e) the devices used or accessed with the transaction; f) file pointers to binary large objects or media (BLOBs) associated with the transaction; g) service level data; h); protocols used; i) security routines and scripts used; j) transfer data; k) offer-specific data such as timestamp, vendor, and expiry of offer; l) demographic information associated with specific product offers; m) data to be used in calculations such as the price per offer made or price per offer campaign; n) data relating to the comparison of similar offers made by a plurality of vendors for the purposes of competitive comparison of offer campaigns.

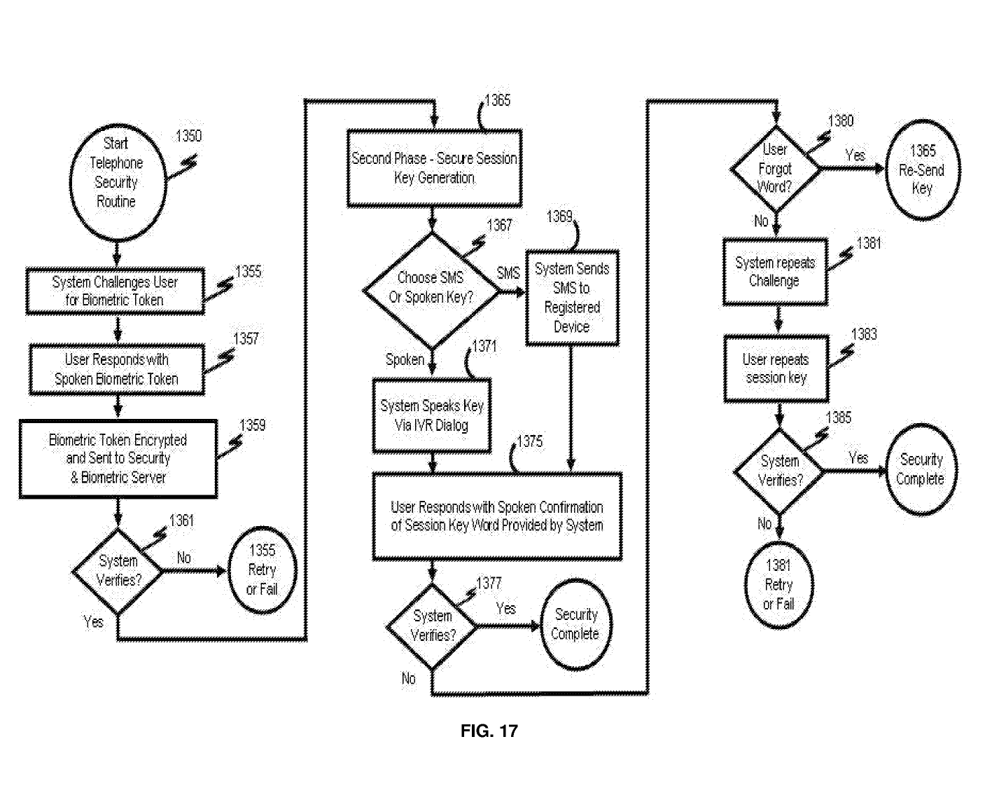

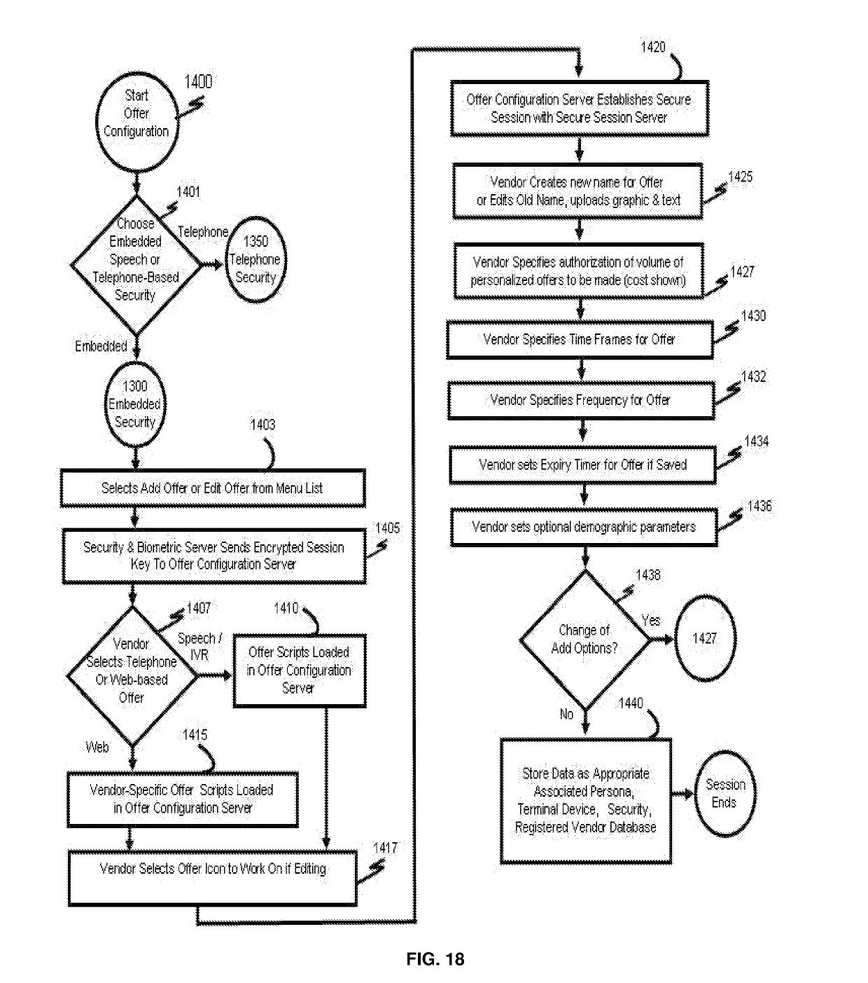

FIG. 4 also shows an embodiment of the persona resources library and database 198. This table or collection of tables is used to store information dealing with the persona corral as described with reference to FIG. 12, FIG. 17, FIG. 18, and FIG. 19. The persona corral is understood to be a collection of user-specific profiles associated with each customer. The persona resources library and database 198 will store relevant and useful data dealing with persona creation, maintenance, and use. Data to be stored will include but not be limited to: a) an identifier of the persona's owner; b) identifier of the particular persona name; c) attributes of the persona dealing with financial or personal data; d) attributes of the persona dealing with social networking information; e) attributes of the persona dealing with preferences such as the time of day for certain communications such as offers; e) attributes of the persona dealing with other preferences such as communications channels; f) attributes of the persona dealing with vendor preferences; g) attributes of the persona dealing with preferences on demographic exposure; h) attributes of the persona dealing with opt-in lists or allowing commercial offers; i) attributes of the persona dealing with security issues and related security data such as token data; j) the types of products or services the customer has an interest in; k) the time frame in which the products or services would be best offered; l) the frequency in which the offers may be presented, m) the preferred time frame in which offers generally may be tendered; and n) the device or plurality of devices or delivery mechanisms in which the offer may be conveyed.

FIG. 5 illustrates one embodiment of the individual application servers and special resources inside of the trust-based personalized offer portal. This is called the application servers 180 architecture. An access point 155 connects the secure database access method 175, described in FIG. 3, to the secure transmission bus. The database access method 175, may also be connected to the database 190.

The trust-based personalized offer portal may utilize not only an array of gateways and a database, but also application servers. As depicted in FIG. 5, the application servers 180 can be a placeholder for the unique applications represented in the entirety of the figure. In one embodiment of the invention, a plurality of applications such as the offer configuration server 181 and the secure session server 165 will be able to run inside of one physical server as depicted by application servers 180 or alternately separated out into separate servers in a distributed environment. Such a distributed environment accommodates the use of remote offer configuration server 181 environments which may be used as dedicated vendor servers as described above with reference to FIG. 4. The practitioner will decide if the concepts associated with each part of the drawing may be optimized by combination or distribution of the same. Microprocessor controlled hardware that may host these application servers is commonly available from vendors such as Dell or Sun Microsystems. The practitioner may choose to equip these physical servers in the same manner explained in FIG. 2 as with the offer portal controller, storage memory, controller memory, communications interface, I/O 30.

FIG. 5 is a block diagram of an embodiment of the invention with the offer configuration server 181 as one of the entities associated with the application servers 180. Here, the offer configuration server 181 has access, via the secure transmission bus, to other servers and connected entities in the trust-based personalized offer portal environment. In addition, the offer configuration server 181 may have access to the secure session servers 165 which are arranged to call upon the array of application servers 180 in the regular duties of setting up and tearing down sessions pertaining to offers and related real time and non-real time transactions.

In particular, the offer configuration server 181 can maintain a working, real-time memory of the vendor-authorized offers deployed in the system. This real-time working memory is able to provide other servers, such as the secure session servers, with particular information about any offer for the expressed purpose of communicating with and sending and receiving commands to and from customers to whom the offers are intended.

The offer configuration server 181 may also act as a service creation environment for authorized vendors, providing vendors with the ability to stipulate the following: a) the volume of single, personalized offers; b) a time-varying element stipulating the start and stop time of the offer; c) a parameter that allows the offer to be later retrieved and redeemed by the customer based on an expiry timer; d) the device or delivery mechanism on which the offer may be made such as TV, browser, or smart phone, or a plurality of devices. These examples are not meant to limit, in any way, the type of parameters and variables that can be configured based upon customized scripts, database entries and capabilities afforded the vendor in the use of the offer configuration server 181. The practitioner will be familiar with a variety of commonly available software tools for creating HTML-based forms with which to solicit input from users which is later stored in a database for later retrieval. Such a common mechanism will allow the practitioner to implement a variety of possible parameters for vendors to contemplate in creating an offer campaign using the offer configuration server 181.

In another embodiment, the offer configuration server 181 also has access to databases such as the vendor and offer scripts database 192 and the persona resources library and database 198. As indicated above, the persona resources library and database 198 contains information established on behalf of each customer such as: a) an identifier of the persona's owner (not to be provided directly to a vendor without explicit permission from the customer); b) identifier of the particular persona name; c) attributes of the persona dealing with financial or personal data; d) attributes of the persona dealing with social networking information; e) attributes of the persona dealing with preferences such as the time of day for certain communications such as offers; e) attributes of the persona dealing with other preferences such as communications channels; f) attributes of the persona dealing with vendor preferences; g) attributes of the persona dealing with preferences on demographic exposure; h) attributes of the persona dealing with opt-in lists or allowing commercial offers; i) attributes of the persona dealing with security issues and related security data such as token data; j) the types of products or services the customer has an interest in; k) the time frame in which the products or services would be best offered; l) the frequency in which the offers may be presented, m) the preferred time frame in which offers generally may be tendered; and n) the device or plurality of devices or delivery mechanisms in which the offer may be conveyed. This data can be valuable in the context of establishing a demographic analysis for particular offer campaigns on behalf of vendors with which to establish an advertising rate model. Such demographic analysis is explained further in the description of the report generation server 186.

In one embodiment of the invention, the offer configuration server 181 software includes a means to provide the vendor (aka advertiser) with a rate structure based on the number of personal offers that can be made to a qualified audience during a particular time period. For example, the vendor may wish to know the volume of personal offers that could possibly be made inside of a specific time frame but only for opted-in customers who are explicitly interested in a certain type of product. the offer configuration server 181 would then query the persona resources library and database 198 in order to calculate those parameters. In this aspect of the invention. The offer configuration server 181 may for example, supply the vendor with an answer indicating that 598 offers could be made in the specified time frame to a specific audience of 302 individuals. The vendor would then ascertain the cost, based on cost per personalized offer, of running that particular targeted offer campaign.

In another embodiment of the invention, customers may stipulate more than one preferred vendor for a particular type of product. In this scenario, the calculations made by the offer configuration server 181 would be governed not only by the frequency by which the customer will tolerate offers, but by the number of opted-in vendors allowed by the customer. In the case of there being more than one preferred vendor, this puts the vendors at odds with one another, the offer configuration server thus creating and presiding over a highly personalized reverse auction for each opted-in customer. As the practitioner will quickly surmise, the decreasing availability of time slots with vendors vying for the same creates a supply and demand scenario that may justify premium rates for certain demographic profiles. In this aspect of the invention, the trust-based personalized offer portal 100 acts as an arbiter between vendors and customers, with the stored parameters of demographic and preference information established by the customer as a constraint that helps to define the limits of each offer.

This constraining methodology is the basis of a “trust” or covenant between the operators of the trust-based personalized offer portal 100 and the customer. That is to say that it is the customer who decides on the frequency of offers, the type of offers and the volume of offers, amongst other parameters, not the operators of the trust-based personalized offer portal 100 and not the vendors. It is this “trust” or covenant between the operators of the trust-based personalized offer portal 100 and the customers that makes each exposure of an offer to the customers a highly personalized solicitation. These constraints or covenants described in this embodiment of the invention in no way limit the way in which a practitioner may implement the invention. It is possible to implement the invention in such a way that constraints are lifted based on the needs of the operator of the trust-based personalized offer portal 100.

In yet another embodiment of the invention, where a plurality of vendors may be engaged simultaneously by using the offer configuration server 181 to design their own, vendor-specific offer campaigns, the customers' demands have a direct impact on the make-up of campaigns vendors will configure using the offer configuration server 181. For example, a group of customers may be accustomed to creating a persona profile that indicates they are interested in time share vacation offers during peak holiday timeframes. Based on diligent use of available demographic information, vendors would then respond by authorizing the trust-based personalized offer portal to “release” 8,000 offers during a time frame relative to specific holidays. If there are only 10,000 possible offer slots available based on the frequency and volume covenant already established with the customers, the vendors may be told they have to limit their order of offer placements during that period. Seeing as this limitation is with a highly qualified audience, the vendor may nonetheless buy the slots and in fact may pay a premium for the same.

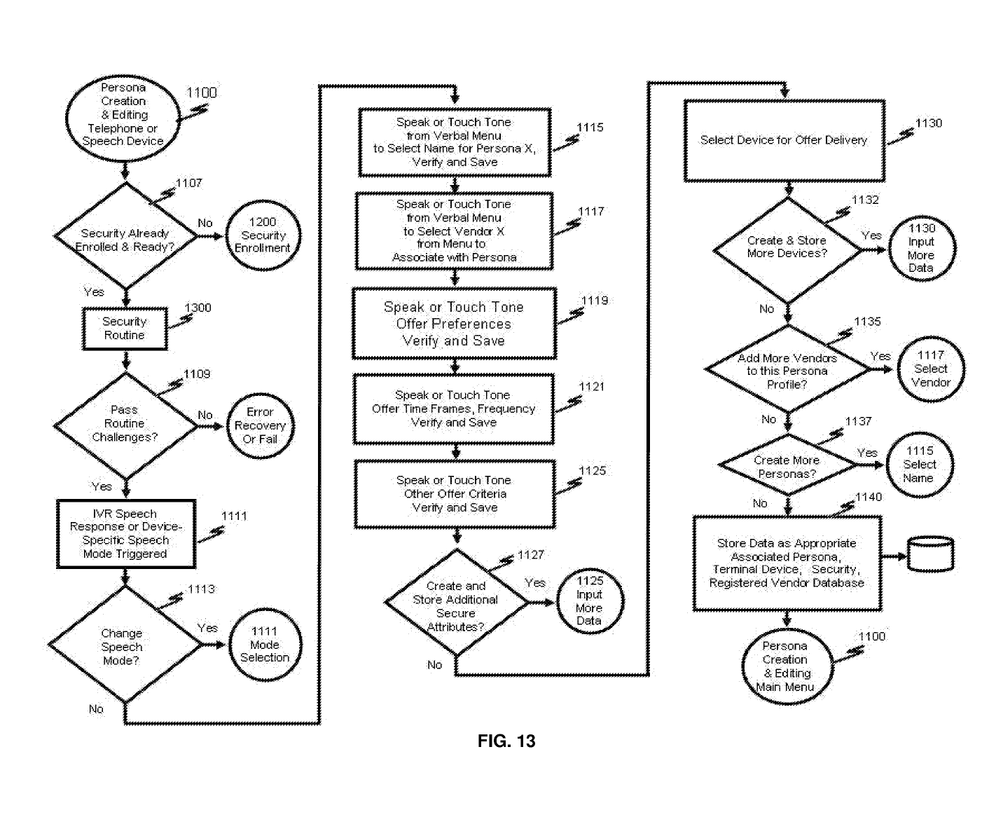

In one embodiment of the invention, where a plurality of vendors may be engaged simultaneously by using the offer configuration server 181 to design their own vendor-specific offer campaigns, vendors may create ad-hoc, one-to-one campaigns or responses based on an ad-hoc request from a customer. For example, in creating a persona corral as explained with reference to FIG. 13 below, a customer may stipulate non-predetermined, non-generic criteria in order to trigger a customized “reverse auction.” For example, a customer may select a set of persona attributes indicating a preference to receive ad hoc offers for a specific desire. Such a desire may be a personalized quote for an automobile paint job or engine tune-up, for example. In such an ad hoc bid request, the customer may open up his vendor preferences—for that set of peculiar persona attributes—to more than one vendor and perhaps vendors who are not identified as “preferred” in the normal, predetermined persona attributes the customer regularly employs. In this context, the offer configuration server 181 can be used by vendors to respond to customers with highly personalized and specific offers.

In another embodiment of the invention, the user interface aggregator matrix 900 is a portable software environment where the offers will appear in the form of an offer inbox or alternate visual or audible indication. This user interface aggregator matrix 900 may be deployed on a TV set-top box, browser, or smart phone for example. In the case of a smart phone deployment, a customer may receive his offer to buy a Hawaii timeshare before the holiday arrives, in time to make a reservation before a reservation deadline. Such a deadline may be triggered by an offer expiry timer that is set by the vendor when using the offer configuration server 181 to create an offer campaign. As per the multiple vendor scenario, the practitioner will see an application for their being more than one offer allowed from more than one vendor. This in effect becomes not only a reverse auction, but a dynamic form of “on line” coupon clipping.

FIG. 5 also depicts an embodiment of the service creation and provisioning server 183 as one of the entities associated with the application servers 180. Here, the service creation and provisioning server 183 has access, via the secure transmission bus, to other servers and connected entities in the trust-based personalized offer portal environment. In addition, the service creation and provisioning server 183 has access to the secure session servers 165, which are arranged to call upon the array of application servers 180. In particular, the service creation and provisioning server 183 provides a means for a system administrator to make changes to the database 190, as depicted in FIG. 4, and by proxy has access, via the secure database access method 175 to of the databases contained in the trust-based personalized offer portal environment. In one embodiment of the invention, the service creation and provisioning server 183 will use a JDBC connection or some other suitable, commercially available database access connection to make changes in the aforementioned databases. The service creation and provisioning server 183 can make updates to the databases using a SOA (services oriented architecture) method such as an HTTPS-based web service method. The practitioner may choose between more direct SQL-based database manipulations or a more decoupled, SOA-based approach without negatively impacting the overall efficacy of the invention. In addition to having access to the databases, the service creation and provisioning server 183 may render a forms-based or graphical representation of the database information required to provision the system. Environments for creating such an interface are commonly available commercially with products from companies such as Microsoft and Oracle for example.

FIG. 5 also depicts one embodiment of the security and biometric server 184 as one of the entities associated with the application servers 180. The security and biometric server 184 has access, via the secure transmission bus, to other servers and connected entities in the trust-based personalized offer portal environment. In addition, the security and biometric server 184 may have access to the secure session servers 165 which are arranged to call upon the array of application servers 180, including the offer configuration server 181, in the regular duties of setting up and tearing down sessions and transactions. In particular, the security and biometric server 184 maintains a working, real-time memory of the security tokens issued for each real-time transaction in use with the system at any one time. This real-time working memory is able to provide other servers, such as the secure session servers, with particular information about any security token for the expressed purpose of communicating with and sending and receiving commands to a offer configuration server 181 or a terminal (user) device such as a web browser 300, smart phone 320, telephone 340, or multimedia/TV set-top box 360. In addition, the real time algorithms, biometric sample corpus, and executables associated with biometric sessions are controlled by the security and biometric server 184. In one embodiment of the invention, the security and biometric server 184 will control the “listening” mode of the media servers, speech and biometric token handling, secure data handling 20 entity as depicted in FIG. 2 and the offer scripts, media server functions 620 entity as depicted in FIG. 3.

This “listening” mode allows the security and biometric server 184 to process spoken signals and match them with biometric samples in the database to establish and verify users in a secure way.

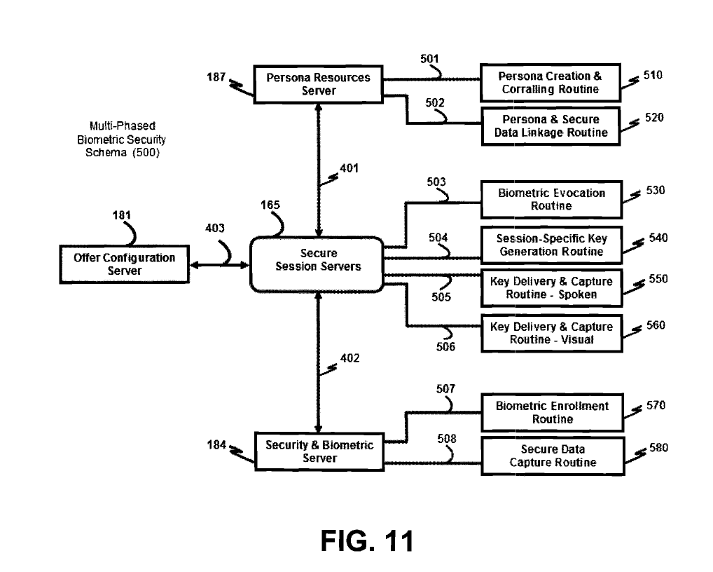

In one embodiment, the users of the trust-based personalized offer portal are not limited to the customers and their end user devices. Vendors may also be users of the trust-based personalized offer portal in that they must have authorized access to the offer configuration server 181 in order to configure their offer campaigns. The multi-phased biometric security schema 500 as depicted in FIG. 11 is the same security schema used for vendors and customers.

The practitioner will implement the security and biometric server 184 and media servers as per FIG. 2 using standard application programming interfaces (APIs) and standard protocols such as media resource control protocol (MRCP), voice extensible markup language (VXML), state control extensible markup language (SCXML), call control extensible markup language (CCXML). Tools and server technology to implement these standards are available from companies such as Voxeo of Orlando, Fla.

FIG. 5 also depicts one embodiment of the report generation server 186 as one of the entities associated with the application servers 180. The report generation server 186 has access, via the secure transmission bus, to other servers and connected entities in the trust-based personalized offer portal environment. In addition, the report generation server 186 has access to the secure session servers 165 which are arranged to call upon the array of application servers 180. In particular, the report generation server 186 provides a means for a system administrator to run diagnostic and management reports based on the real time information stored in volatile memory of the application servers 180 and the historical information stored in the database 190, as depicted in FIG. 4. By proxy the report generation server 186 has access, via the secure database access method 175, to the databases contained in the trust-based personalized offer portal environment. In one embodiment of the invention, the report generation server 186 will use a JDBC connection or some other suitable, commercially available database access connection to query the aforementioned databases. In one aspect of the invention, the report generation server 186 can get database information for reporting purposes by using a SOA (services oriented architecture) method such as an HTTPS-based web service method.

The practitioner may choose between more direct SQL-based database queries or a more decoupled, SOA-based approach without negatively impacting the overall efficacy of the invention. In addition to having access to the databases, the report generation server 186 will be used to render reports in common formats such as eXtensible Markup Language (XML), or HyperText Markup Language (HTML). Such reports may be rendered using commercially available tools such as the open source tools available from JasperForge.org.

In another embodiment, the report generation server 186 will provide restricted access to certain data such that not only administrators of the portal can run reports, but also vendors will be able to run reports, using the offer configuration server 181 as the entry point for those reports. Such reports may actually be rendered by the report generation server 186. Again, the persona resources library and database 198 contains information established on behalf of each customer such as: a) an identifier of the persona's owner (not to be provided directly to a vendor without explicit permission from the customer); b) identifier of the particular persona name; c) attributes of the persona dealing with financial or personal data; d) attributes of the persona dealing with social networking information; e) attributes of the persona dealing with preferences such as the time of day for certain communications such as offers; e) attributes of the persona dealing with other preferences such as communications channels; f) attributes of the persona dealing with vendor preferences; g) attributes of the persona dealing with preferences on demographic exposure; h) attributes of the persona dealing with opt-in lists or allowing commercial offers; i) attributes of the persona dealing with security issues and related security data such as token data; j) the types of products or services the customer has an interest in; k) the time frame in which the products or services would be best offered; 1) the frequency in which the offers may be presented, m) the preferred time frame in which offers generally may be tendered; and n) the device or plurality of devices or delivery mechanisms in which the offer may be conveyed.

These data can be valuable to vendors who whish to ascertain the efficacy and overall cost effectiveness of certain offer campaigns. For example, the report generation server can be used to roll-up data on how many offers for a certain product were viewed and accepted by a certain demographic profile of customers based on a campaign or plurality of campaigns. Such data would be “scrubbed” by the report generation server 186 to eliminate any highly personal or private data of a specific customer.

In this embodiment of the invention, offer campaign impact data can be used to justify more campaign expenditures, or it may be used to justify paying a premium for offers during certain time frames. Such decision-making shall not be limited to vendors. The practitioner will quickly realize that the analysis of offer campaign data can be useful for the operators of the trust-based personalized offer portal in advising vendors what rates of pay for offer campaigns are justified.

FIG. 5 also shows an embodiment of the persona resources server 187 as one of the entities associated with the application servers 180. The persona resources server 187 has access, via the secure transmission bus, to other servers and connected entities in the trust-based personalized offer portal environment. In particular, the vendor persona resources server 187 maintains a working, real-time memory of the customer personas to be used by the offer configuration servers 181 deployed in the system. This real-time working memory is able to provide other servers, such as the secure session servers, with particular information about any persona for the expressed purpose of establishing vendor and offer preferences. In particular, the persona resources server 187 contains a working memory of each persona corral, which is a collection of user-specific profiles associated with each customer. The persona resources server 187 has access to the persona resources library and database 198, which stores relevant and useful data dealing with persona creation, maintenance, and use. The persona resources server has access to and sends commands to other servers based on persona information including, but not be limited to: a) an identifier of the persona's owner; b) identifier of the particular persona name; c) attributes of the persona dealing with financial or personal data; d) attributes of the persona dealing with social networking information; e) attributes of the persona dealing with preferences such as the time of day for certain communications; e) attributes of the persona dealing with other preferences such as communications channels; f) attributes of the persona dealing with vendor preferences; g) attributes of the persona dealing with preferences on demographic exposure; h) attributes of the persona dealing with opt-in lists or allowing commercial offers; i) attributes of the persona dealing with security issues and related security data such as token data; j) the types of products or services the customer has an interest in; k) the time frame in which the products or services would be best offered; l) the frequency in which the offers may be presented, m) the preferred time frame in which offers generally may be tendered; and n) the device or plurality of devices or delivery mechanisms in which the offer may be conveyed.

FIG. 5 also depicts one embodiment of the terminal device protocol server 189 as one of the entities associated with the application servers 180. The terminal device protocol server 189 has access, via the secure transmission bus, to other servers and connected entities in the trust-based personalized offer portal environment. In addition, the terminal device protocol server 189 has access to the secure session servers 165 which are arranged to call upon the array of application servers 180, including the offer configuration server 181, in the regular duties of setting up and tearing down sessions and transactions. In particular, the terminal device protocol server 189 maintains a working, real-time memory of the terminal devices to be used by customers of the trust-based personalized offer portal and the offer configuration servers 181 deployed in the system.

In one embodiment, this real-time working memory is able to provide other servers, such as the secure session servers, with particular information about any terminal device for the purpose of communicating with and connecting these devices to end points including, but not limited to: a) vendor call centers and IVR systems; b) vendor web sites; and c) social networking web sites that are connected to the trust-based personalized offer portal. the terminal device protocol server 189 will store information that makes it possible to answer calls from or make calls to these devices over a variety of media. In particular, the terminal device protocol server 189 will have access to the terminal device database 191 which enables the server to identify terminal devices by their user and to identify how to reach those devices.

The terminal device database 191 also stores protocol information the terminal device protocol server 189 can act upon on behalf of each user. Such information includes, but is not limited to the following: a) the unique telephone number or other address that makes the device addressable by the application; b) the communication protocol associated with the device. Such protocols may be but are not limited to SIP, 3G, PSTN, or IP; c) the order of preference for device use by each user of the application; d) alternate devices associated with the user of the application; e) security token and session token information; and f) any attributes which distinguish a specific device as to suitability for direct use by users of the application via the trust-based personalized offer portal.

FIG. 6 is a block diagram illustrating one embodiment of the architecture for the web browser 300 user device (terminal device). As depicted in the figure, web browser 300 is connected to the PSTN, IP or MTSO switching network 240 via access point 250. This is the means for the trust-based personalized offer portal to communicate with the terminal device on behalf of customers and vendors, both of which will be registered in the system as users.

Web browser technologies will be well known to the practitioner. There are a variety of application programming interfaces (APIs), development environment (DE) and run time environments (RTE) that will support a suitable environment for the invention. The browser environment 302 connected to the web browser 300 is the receptacle for these APIs, DE and RTE. Programming tools for Sun Microsystems Java, Adobe Flash, Adobe Flex and others are commonly available to the practitioner.

As depicted in FIG. 6, in one embodiment of the invention, the browser environment 302 is the common receptacle for the user interface aggregator matrix 900, which is connected to the browser environment at access point 305. The user interface aggregator matrix 900 provides a unified look and feel to the trust-based personalized offer portal end user interface. The user interface aggregator matrix 900 uses the same approach and methodology regardless of the terminal device it is deployed on. A particular aspect of the user interface aggregator matrix 900 as per each terminal device, is that its communications plug-in 910 connected as access point 901 will be adapted to the specific user environment of that specific user device. That is, the communications plug-in 910 will have a parameter-based option to allow the user interface aggregator matrix 900 to run in a browser environment 302, a smart phone environment 322 as depicted in FIG. 7, a VoIP software-based telephone environment 344 as depicted in FIG. 8, or a multimedia/TC set-top box environment 362 as depicted in FIG. 9. The communications plug-in 910 will be implemented in such a way as to not preclude its use in a variety of other environments including but not limited to live radio broadcast, two-way video communications or other multimedia communications environments. One purpose of the communications plug-in 910 is to communicate with the terminal device protocol server 189 as described in FIG. 5 and the secure session servers 165 as described in FIG. 3. These communications will occur using the protocols governed by the terminal device protocol server 189 and the secure session servers 165 as they related to the particular terminal device, the profile of which is stored in the terminal device database 191 as described in FIG. 4.

Another embodiment of the invention as shown in FIG. 6 is the security plug-in 920, which is connected to the user interface aggregator matrix 900 via access point 902. Here, the security plug-in, as with the communications plug-in 910, is a common element of the user interface aggregator matrix 900 regardless of terminal device. The security plug-in will have a parameter-based option to allow the user interface aggregator matrix 900 to run in a browser environment 302, a smart phone environment 322 as depicted in FIG. 7, a VoIP software-based telephone environment 344 as depicted in FIG. 8, or a multimedia/TC set-top box environment 362 as depicted in FIG. 9. The security plug-in 920 may be implemented in such a way as to not preclude its use in a variety of other environments, including, but not limited to, live radio broadcast, two-way video communications or other multimedia communications environments.

One purpose of the security plug-in 920 is to communicate with the security and biometric server 184 as described in FIG. 5 and the secure session servers 165 as described in FIG. 3. These communications will occur using the rules and protocols governed by the security and biometric server 184 and the secure session servers 165 as they related to the particular terminal device, the profile of which is stored in the terminal device database 191 as described in FIG. 4. In addition, the security plug-in 920 acts as a secure mechanism to handle other secure data including but not limited to secure session keys and passwords created and used on behalf of the user.

FIG. 6 also depicts another aspect of the invention called the vendor plug-ins 930 which are connected to the user interface aggregator matrix 900 at access point 903. vendor plug-ins are software that allows for the arrangement and selection of vendor-based connections by the user. A more detailed view of the vendor plug-ins 930 is depicted in FIG. 10.

FIG. 6 also depicts another aspect of the invention called the persona plug-ins 940, which may be connected to the user interface aggregator matrix 900 at access point 904. Persona plug-ins are software that allows for the configuration, arrangement and selection of personas and a persona corral by the user. A persona is a collection of attributes, created by the user, that represent a plurality of incrementally intimate and secure aspects of the relationship between the user and the vendor, and the user and a social networking site, and the user and other users. A more detailed view of the persona plug-ins 940 is depicted in FIG. 10.

FIG. 7 illustrates one embodiment of the architecture for the smart phone 320 user device (terminal device). As depicted in the figure, smart phone 320 is connected to the PSTN, IP or MTSO switching network 240 via access point 251. This is the means for the trust-based personalized offer portal to communicate with the terminal device on behalf of customers and vendors, both of which may be registered in the system as users. The smart phone 320 is also connected to the smart phone environment 322 via access point 321.

Smart phone technologies will be well known to the practitioner. There are a variety of application programming interfaces (APIs), development environment (DE) and run time environments (RTE) that will support a suitable environment for the invention. The smart phone environment 322 connected to the smart phone 320 is the receptacle for these APIs, DE and RTE. Programming tools for Sun Microsystems Java, Adobe Flash, Adobe Flex and others are commonly available to the practitioner. Other environments suitable for development on a smart phone may include, but are not limited to environments such as those provided by Apple Computer for its iPhone applications.

As depicted in FIG. 7, the smart phone environment 322 may be the common receptacle for the user interface aggregator matrix 900 that is connected to the smart phone environment 322 at access point 325. As with the web browser user device 300 as depicted in FIG. 6, the user interface aggregator matrix 900 provides a unified look and feel to the trust-based personalized offer portal end user interface. The user interface aggregator matrix 900 uses the same approach and methodology regardless of the terminal device it is deployed on. A particular aspect of the user interface aggregator matrix 900 as per each terminal device, is that its communications plug-in 910 connected as access point 901 may be adapted to the specific user environment of that specific user device as described with reference to FIG. 9.

Another aspect of the invention as shown in FIG. 7 is the security plug-in 920 which is connected to the user interface aggregator matrix 900 via access point 902 as described in FIG. 6. the security plug-in, as with the communications plug-in 910, is a common element of the user interface aggregator matrix 900 regardless of terminal device.

FIG. 7 also depicts another aspect of the invention called the vendor plug-ins 930 which in this embodiment, are connected to the user interface aggregator matrix 900 at access point 903. The utility of the vendor plug-ins 930 as they relate to the smart phone environment 322 are inclusive of, but not limited to the capabilities described in FIG. 6 and the detailed view in FIG. 10.

FIG. 7 also depicts another aspect of the invention called the persona plug-ins 940 which may be connected to the user interface aggregator matrix 900 at access point 904. The utility of the persona plug-ins 940 as they relate to the smart phone environment 322 are inclusive of, but not limited to the capabilities described in FIG. 6 and the detailed view in FIG. 10.

FIG. 8 is a block diagram showing one embodiment of the architecture for the telephone 340 user device (terminal device). In further detail, telephone 340 is connected to the PSTN, IP or MTSO switching network 240 via access point 252. This is the means for the trust-based personalized offer portal to communicate with the terminal device on behalf of customers and vendors, both of which will be registered in the system as users.

Both regular telephone and voice over internet protocol telephone (VoIP Telephone) technologies will be well known to the practitioner. There is a variety of application programming interfaces (APIs), development environment (DE) and run time environments (RTE) that will support a suitable environment for VoIP telephones contemplated as suitable for the invention. In addition, commonly available interactive voice response (IVR) technologies may be used to link regular telephone users to the trust-based personalized offer portal. The owners of such regular telephone terminal devices may not have ready access to software-based user devices; however, a commonly available user interface and methodology for transcribing speech and touch tone input into computer commands via IVR is well known and commercially available. For example, Dialogic, Nuance and Voxeo are companies amongst dozens of others that make this technology available to the practitioner.

In this context, the access point 341, which connects telephone 340 to the VoIP software-based telephone environment 344, may embody a customer premises equipment or network-based connection to the IVR system mentioned here. The purpose of such an IVR system is to take speech or touch-tone based input from the user and map it to the VoIP software-based telephone environment 344. Here, the PSTN/POTS telephone reference card 342 is a placeholder for the mapped speech or touch tone commands a user would employ to achieve the necessary software access to the same commands available in the VoIP software-based telephone environment 344. The PSTN/POTS telephone reference card 342 is a reference document that users of the telephone interface can use as a guide.

In an alternate embodiment of this aspect of the invention, the VoIP software-based telephone environment 344 may incorporate an IVR capability and be deployed as part of the media server, speech and biometric token handling, secure data handling 20 device as described with reference to FIG. 2.

In the telephone user device 340, the VoIP software-based telephone environment will natively connect to commonly available physical VoIP phones, such as those available from Cisco or Polycom. Alternately, the VoIP software-based telephone environment will natively connect to software-based VoIP phones such as those available from Skype or Microsoft. A common attribute of VoIP phones is their ability to accept and process commands based on visual, screen-based or LED-based prompts associated with the device. The practitioner will use commercially and commonly available applications programming interfaces (APIs), supplied by the VoIP vendors, or proprietary drivers, supplied by the VoIP vendors to allow the VoIP software-based telephone environment 344 to interoperate with these terminal devices.

With reference to FIG. 8, the VoIP software-based telephone environment 344 is the common receptacle for the user interface aggregator matrix 900 which is connected to VoIP software-based telephone environment 344 at access point 347. As with the web browser user device 300 as depicted in FIG. 6, the user interface aggregator matrix 900 provides a unified look and feel to the trust-based personalized offer portal user interface. The user interface aggregator matrix 900 may use the same approach and methodology regardless of the terminal device it is deployed on. A particular aspect of the user interface aggregator matrix 900 as per each terminal device, is that its communications plug-in 910 connected as access point 901 will be adapted to the specific user environment of that specific user device as described in FIG. 9.

Another aspect of the invention is the security plug-in 920 which is connected to the user interface aggregator matrix 900 via access point 902 as described in FIG. 6. In this embodiment, the security plug-in, as with the communications plug-in 910, is a common element of the user interface aggregator matrix 900 regardless of terminal device.

FIG. 8 also depicts another aspect of the invention called the vendor plug-ins 930 which are connected to the user interface aggregator matrix 900 at access point 903. The utility of the vendor plug-ins 930 as they relate to the VoIP software-based telephone environment 344 are inclusive of, but not limited to the capabilities described in FIG. 6 and the detailed view in FIG. 10.

FIG. 8 also depicts another aspect of the invention called the persona plug-ins 940 which are connected to the user interface aggregator matrix 900 at access point 904. The utility of the persona plug-ins 940 as they relate to the voip software-based telephone environment 344 are inclusive of, but not limited to the capabilities described in FIG. 6 and the detailed view in FIG. 10.

FIG. 9 is a block diagram illustrating one embodiment of the architecture for the multimedia/TV set-top box 360 user device (terminal device), which is connected to the Cable TV, IP TV, satellite, multimedia network 260 via access point 253. This is the means for the trust-based personalized offer portal to communicate with the terminal device on behalf of customers and vendors, both of which will be registered in the system as users. The multimedia/TV set-top box 360 is also connected to the multimedia/TV set-top box environment 362 via access point 361.

Technologies typifying the multimedia/TV set-top box 360 will be well known to the practitioner, as they are based on common microprocessor-based computer devices. As with a browser-based environment, there are a variety of application programming interfaces (APIs), development environment (DE) and run time environments (RTE) that will support a suitable environment for the invention. The multimedia/TV set-top box environment 362 connected to the multimedia/TV set-top box 360 is the receptacle for these APIs, DE and RTE. Programming tools for Sun Microsystems Java, Adobe Flash, Adobe Flex and others are commonly available to the practitioner.

FIG. 9 depicts one embodiment of the multimedia/TV set-top box environment 362 is the common receptacle for the user interface aggregator matrix 900 which is connected to the multimedia/TV set-top box environment 362 at access point 355. As with the web browser user device 300 as depicted in FIG. 6, the user interface aggregator matrix 900 provides a unified look and feel to the trust-based personalized offer portal end user interface. The user interface aggregator matrix 900 uses the same approach and methodology regardless of the terminal device it is deployed on. A particular aspect of the user interface aggregator matrix 900 as per each terminal device, is that its communications plug-In 910 connected as access point 901 may be adapted to the specific user environment of that specific user device as described in FIG. 9.

Another aspect of the multimedia/TV Set set-top box environment 362 as it relates to Multimedia/TV set-top box 360 user devices is the interoperability and communication with associated user devices such as remote controls. In this embodiment of the invention, the remote control acts as a “keyboard,” allowing the user to provide input into the multimedia/TV set-top box environment 362. Another aspect of the invention as it relates to the multimedia/TV set-top box environment 362 is the option to derive input from users via embedded speech devices which may be available in certain multimedia/TV set top box 360 user devices. In one embodiment of the invention, the multimedia/TV set top box 360 user device will employ its own embedded speech capability as an alternative input device versus the remote control. In another aspect of the invention, the TV set top box 360 user device will act as a gateway to more traditional speech or touch-tone input mechanisms such as a network-based interactive voice response (IVR) system.

Another aspect of the invention as shown in FIG. 9 is the security plug-in 920 which is connected to the user interface aggregator matrix 900 via access point 902 as described with reference to FIG. 6. The security plug-in, as with the communications plug-in 910, is a common element of the user interface aggregator matrix 900 regardless of terminal device.

FIG. 9 also depicts another aspect of the invention called the vendor plug-ins 930 which may be connected to the user interface aggregator matrix 900 at access point 903. The utility of the vendor plug-ins 930 as they relate to the smart multimedia/TV set top box environment 362 are inclusive of, but not limited to the capabilities described in FIG. 6 and the detailed view in FIG. 10.

FIG. 9 also depicts another aspect of the invention called the persona plug-ins 940 which may be connected to the user interface aggregator matrix 900 at access point 904. The utility of the persona plug-ins 940 as they relate to the multimedia/TV set top box environment 362 are inclusive of, but not limited to the capabilities described in FIG. 6 and the detailed view in FIG. 10.

The block diagram of FIG. 10 shows one embodiment of the architecture for the common user interface aggregator matrix 900. In particular, this view of the common user interface aggregator matrix concentrates on the vendor plug-ins 930, persona plug-ins 940 and social plug-ins 950. Some aspects of the invention dealing with the communications plug-in 910 and the security plug-in 920 are explained above with reference to FIG. 6.

Vendor plug-ins 930 are connected to the user interface aggregator matrix 900 at access point 903. Vendor plug-ins 930 are software that allows for the arrangement and selection of vendor-based connections by the user. Each individual vendor plug-in 930 is depicted in FIG. 10 as vendor X, vendor Y and vendor N. This establishes that vendor plug-ins 930 are manifest in a plurality of vendor representations. Vendor X, for example may represent a commercial banking operation. Vendor Y, for example may represent a catalog household goods operation. Vendor N, for example may represent an automobile service center operation. The purpose of allowing the customer to define parameters for use with these vendor plug-ins is to establish the customers' vendor preferences and attributes pertaining to offer limitations, frequency and type. There are many other combinations that can be contemplated in another aspect of the invention and therefore vendor plug-ins 930 are not limited to these examples. In this context, the user interface aggregator matrix seeks to normalize, unify and make a single interface available for the user, eliminating separate user interfaces and labor required to communicate preferences to vendors. Through the linkages described earlier to the offer configuration server 181 and the automated scripts stored in the vendor and offer scripts and library 192, and the general session control afforded by the secure session servers 165, the trust-based personalized offer portal acts as a general aggregator of secure sessions and commercial offers in one aspect of the invention, whilst providing a unified, singular interface to the user in another aspect of the invention.

In a one embodiment of the invention, the make up and stored attributes for the vendor plug-ins 930 will be created and provisioned with the user interface as described as part of the service creation and provisioning server 183 shown in FIG. 5. The specific parameters used to communicate with the vendor systems represented by the vendor plug-ins 930, are based on the offer configuration server 181 (connected by access point 962 to the vendor plug-ins 930). The offer configuration server 181 will used “scrubbed” data stored in the persona resources library and database 198, and the terminal device database 191, and the vendor and offer scripts database 192 to determine what offers to make and what preferred devices the offers will be conveyed on. By “scrubbed” the practitioner will understand that one of the aspects of the invention is its ability to provide vendors with customer-specific demographic information without revealing private data unless under the explicit permission of the customer.

The secure session servers 165, as depicted in FIG. 3 will be used to govern each particular session in which a vendor plug-in 930 is evoked, so the appropriate application servers 180 will come in to play for specific functions. For example, the secure session servers 165 will work in tandem with the security and biometric server 184 to verify the identity of users for secure interactions. The multi-phased biometric security schema 500 which is governed in part by the security and biometric server 184 is explained in further detail below with reference to FIG. 11.

As depicted in FIG. 10, each vendor plug-in may have a distinct and separate manifestation based on its rendering in the user device which is under the control of the user interface aggregator matrix 900. For example, the selection of vendor X, versus vendor Y, versus vendor N by the customer may be different in a browser environment 302 than that of a VoIP software-based telephone environment 344 (See FIG. 8). Specifically, the choice of vendor Y in a browser environment 302 may require a right mouse click on a visual icon in the form of the vendor's commercial logo which is arranged on a web site along with other logos representing other vendor plug-ins 930 Likewise, in another aspect of the invention, the choice of vendor X in a VoIP software-based telephone environment 344 may manifest in a verbal IVR menu choice, with no visual icon. Alternately, the choice of vendor X in a VoIP Software-based telephony environment 344 may manifest in a soft button associated with a physical VoIP telephone instrument. In the context of its use under the overall user interface aggregator matrix 900, vendor plug-ins 930 are the “destination” or one of plurality of receptacles for a dialog the user wishes to originate with a specific persona plug-in 940. In another aspect of the invention the icons used to represent certain products may be selected by the customer. For example, the customer may choose from a pick list of icons that represent automobile offers or products—such as a graphical rendering of an automobile. It is important to note that the trust-based personalized offer portal does not preclude the practitioner's ability to implement the invention in such a way that the user interface aggregator matrix will be used to govern the use of stored icons provided by the vendors or by the operators of the trust-based personalized offer portal.

The block diagram of FIG. 10 depicts another aspect of the invention called the persona plug-ins 940 which may be connected to the user interface aggregator matrix 900 at access point 904. persona plug-ins are software that allows for the configuration, arrangement and selection of personas and a persona corral by the user. A persona is a collection of attributes, created by the user, that represent a plurality of incrementally intimate and secure aspects of the relationship between the user and the vendor or vendors, and the user and other users. Each individual persona plug-in 940 is depicted in FIG. 10 as persona X, persona Y and persona N. This establishes that persona plug-ins 940 are manifest in a plurality of personalized representations. Persona X, for example may represent a persona who is configured to provide private commercial banking account numbers that can be used by a vendor plug-in 930. Persona Y, for example may represent a persona that has no secure, financial elements, but nonetheless has an attribute for allowing an offer “opt-in” for a particular vendor or a group of vendors who have similar products. Persona N, for example may represent a persona that was created specifically for establishing a dialog with a plurality of vendors for an ad hoc reverse auction, in which the customers' personas in this case are used as a signal to trigger a call to action for vendors to provide a personalized offer campaign for a particular customer. Such a persona N may be used as a one-time or “throw away” persona as opposed to personas X and Y which are for more regular, canned offer permissions. Further, persona N may be configured as a “chatty” persona who allows a one-time chat message dialog associated with a specific reverse auction. Such a chat dialog permission would expire upon the fulfillment or termination of the offer in question. Such a chat message permission will then be used in conjunction with the offer configuration server 181, where an indication that the customer is allowing a real-time chat communication will be displayed to the vendor or vendors invited to make offers for that particular (throw-away) persona. There are many other combinations that can be contemplated in other embodiments of the invention and therefore persona plug-ins 940 are not limited to these examples.

The make up and stored attributes for the persona plug-ins 940 may be created and provisioned with the user interface as described FIG. 12 common user interface creation of persona corral—logic flow 1000. The specific protocols and parameters used to communicate with vendors will be stored in the vendor and offer scripts database 192 as depicted in FIG. 4. The secure session servers 165, as depicted in FIG. 3 will be used to govern each particular session in which a persona plug-in 940 is evoked, so the appropriate application servers 180 will come in to play for specific functions. For example, the secure session servers 165 will work in tandem with the security and biometric server 184 to verify the identity of users for secure interactions. The multi-phased biometric security schema 500 which is governed in part by the security and biometric server 184 is explained in further detail in FIG. 11. In addition, persona plug-ins 940 will access the persona resources server 187 which has access to stored persona data in the persona resources library and database 198 as described above in relation to FIG. 4.

As shown in FIG. 10, each persona plug-in may have a distinct and separate manifestation based on its rendering in the user device which is under the control of the user interface aggregator matrix 900. For example, the selection of persona X, versus persona Y, versus persona N by the customer may be different in a browser environment 302 than that of a VoIP software-based telephone environment 344. Specifically, the choice of persona Y in a browser environment 302 my require a right mouse click on a visual icon in the form of the persona's icon or avatar which is arranged on a web site along with other icons representing other persona plug-Ins 930. Likewise, in another aspect of the invention, the choice of persona X in a VoIP software-based telephone environment 344 may manifest in a verbal IVR menu choice, with no visual icon. Alternately, the choice of persona N in a VoIP software-based telephony environment 344 may manifest in a soft button associated with a physical VoIP telephone instrument. In the context of its use under the overall user interface aggregator matrix 900, persona plug-ins 940 are the items that get dragged on to, or are associated with a specific or group of vendor plug-ins 930. A communication is started based on the user associating any persona with one or more vendor plug-ins 930. This is but one means for a reverse auction type of persona to trigger an offer response from one or more vendors for a more immediate response. In another aspect of the invention, the attributes stored with non-reverse auction personas are more canned and used as the basis for mass offers created in the offer configuration server 181 by vendors in the normal course of creating outbound offer campaigns.

FIG. 11 is a block diagram illustrating one embodiment of the multi-phased biometric security schema 500. Central to the security schema is the secure session servers 165. The secure session servers 165 are able to connect to other application services and special resources 15 over the secure transmission bus 160 and its related access points. In FIG. 11, the access points representing the secure transmission bus are 401, 402, and 403 which may connect the secure session servers to the persona resources server 187, security and biometric server 184, and the offer configuration server 181, respectively.

One aspect of the multi-phased biometric security schema 500 is the routine for creating a persona and adding it to the personal corral. One embodiment of this is depicted in FIG. 11 as persona creation and corralling routine 510 connected logically to the persona resources server 187 over access point 501. In this routine, certain private financial and personal data may be collected by the system. Such information being sensitive, it is therefore necessary to ensure that the user of the system who is creating the persona is verified. After user verification, the user is then challenged for a password. In this embodiment, these two steps, which may be preceded by a biometric enrollment, are prerequisites to creating, editing and corralling personas. The logic flow for these steps is set forth in FIG. 12. Also associated with the persona resources server 187 over access point 502 is the persona and secure data linkage routine 520. Here, the persona and secure data linkage routine takes the output from the data entered by the user with their terminal device (user device), and encrypts this data. This encrypted data is then associated with a session encryption key, which is generated by the security and biometric server 184 and passed on to the secure session servers 165 each time a session is started. A session may include an interaction to create, edit or corral a persona using a persona plug-in 940; or to associate a persona with a vendor plug-in 930.

The association between a persona using the persona plug-in 940 with a vendor plug-in 930 is not necessarily limited to a one-to-one relationship between these elements. In another embodiment of the invention, multiple, simultaneous associations may be achieved. Each time the user makes an association with these elements, a session is created by the secure session server. That is, unless a secure session and related secure session token has already been created and the action of association is a continuation of an existing session. The persona and secure data linkage routine 520 is a standard security procedure that governs the use of encrypted session keys created by the security and biometric server 184. The association of those keys with a specific session are created and maintained by the secure session servers 165, and linked logically to the persona in use by the persona resources server 187. In one embodiment of the invention, the transmissions dealing with the persona creation and corralling routine 510 and the persona and secure data linkage routine 520 are encrypted during transmission and encrypted when stored. The practitioner will be familiar with the industry best practices associated with this encryption as described in detail by the payment card industry data security standard (PCI DSS) as defined by the PCI security standards council.

Another aspect of the multi-phased biometric security schema 500 as depicted in FIG. 11 is the biometric evocation routine 530. The biometric evocation routine 530 may be connected to the secure session servers 165 at access point 503. In this routine, a match-up of a user's voice is compared to a previously captured sample of the user's voice in order to verify identity. The practitioner will find industry standard examples of such an implementation of biometric evocation as per software supplied by Nuance and IBM for example.

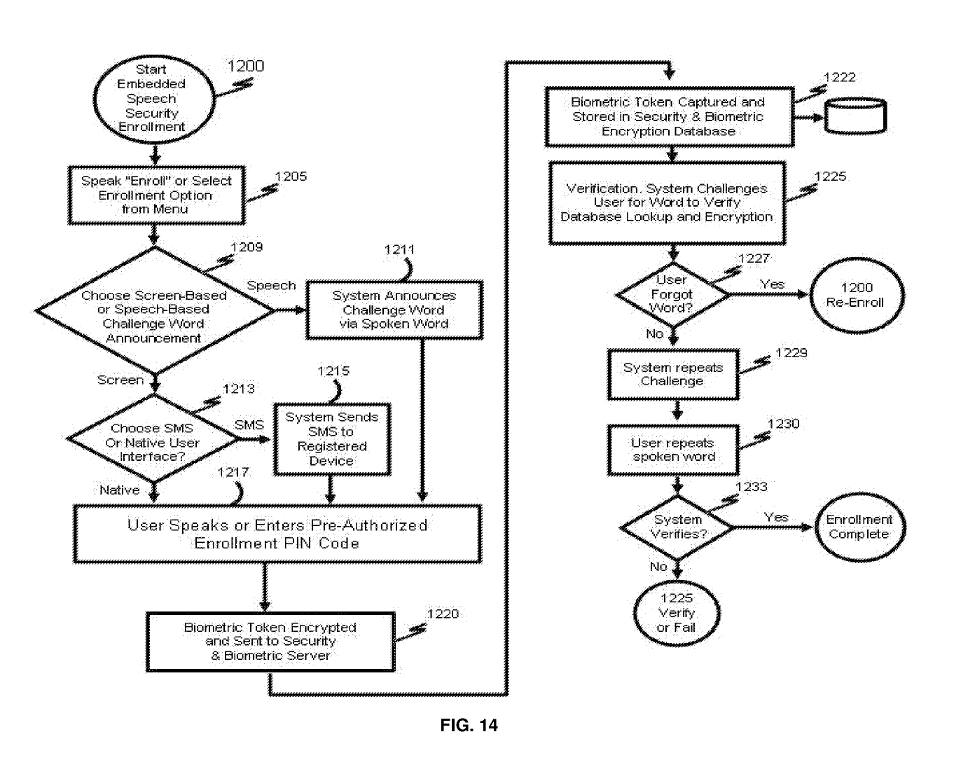

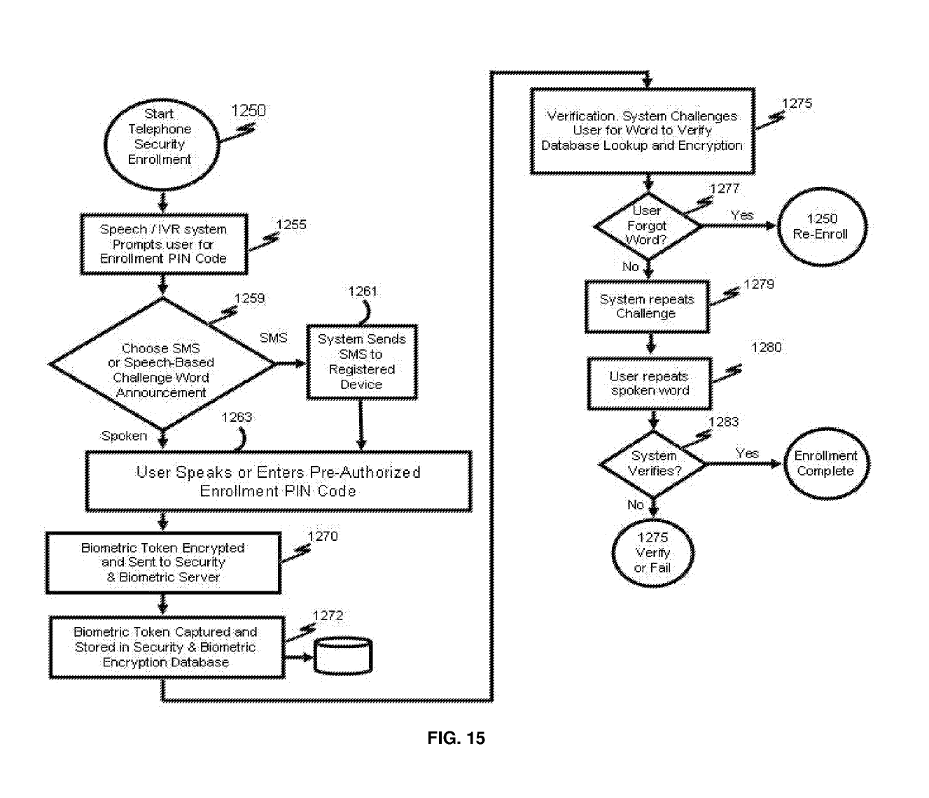

Such evocation may occur in two circumstances as it relates to the trust-based personalized offer portal 100. First, a biometric evocation may happen during the biometric enrollment routine 570 as explained later here in association with FIG. 11. Embodiments of the biometric enrollment routine 570 are further explained in connection with FIG. 14 and FIG. 15. Second, biometric evocation may be used as part of the secure data capture routine 580 as explained later here in association with FIG. 11.

Another aspect of the multi-phased biometric security schema 500 as depicted in FIG. 11 is the session-specific key generation routine 540. The session-specific key generation routine 540 is connected logically to the secure session servers 165 at access point 504. In this routine, an encrypted session number is generated by the security and biometric server 184 at the establishment of a session created by the secure session server 165. Once the key is generated by the security and biometric server 184 it is then encrypted and passed on to the secure session server 165 and then used for the remainder of the session. The key token is then “thrown away” at the termination of the session. The knowledge of how to implement this key token model is commonly available. The practitioner will find instructions on how to generate, encrypt, and use keys and tokens as per examples provided by the well-known Diffie-Hellman key exchange cryptographic protocol or RSA security models.

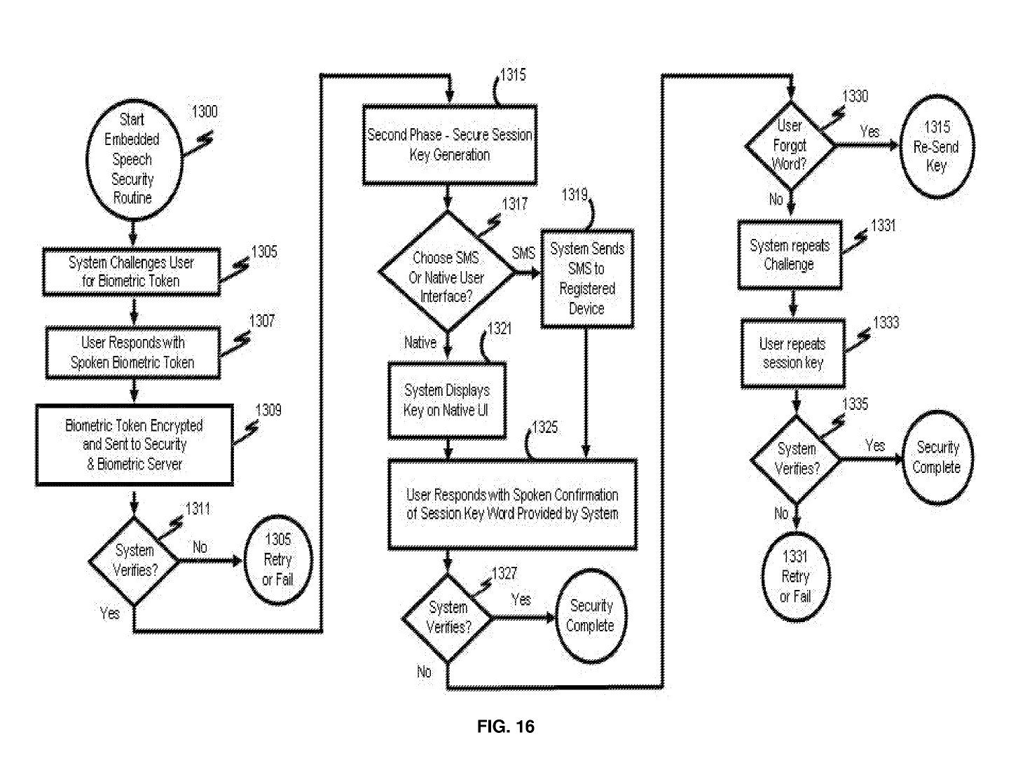

Another aspect of the multi-phased biometric security schema 500 as depicted in FIG. 11 is the key delivery and capture routine—spoken 550. In one embodiment, the key delivery and capture routine—spoken 550 is connected to the secure session servers 165 at access point 505. In this routine, an encrypted, user-facing token is generated by the security and biometric server 184 at the establishment of a session created by the secure session server 165. Once the encrypted, user-facing token is generated by the security and biometric server 184 it is then passed on to the secure session server 165 and then used to establish the validity of the session by challenging the user for a “read-back” of the encrypted, user-facing token once it is rendered at the user terminal device. Such a user-facing token may be spoken by an imbedded speech mechanism at the point of the terminal device, or it may be spoken in a more traditional manner by way of a standard interactive voice response (IVR) delivery. If by embedded speech mechanism at the user device, a command will be sent to the device via the session control, voice gateway, SMS, chat, email gateway 10 as described in FIG. 2. If by IVR, the user-facing token will be spoken out by the session control, voice gateway, SMS, chat, email gateway 10 as described with reference to FIG. 2. The user will then respond the challenge of this spoken user-facing token by repeating it back to the system. The media server, speech and biometric token handling, secure data handling 20 element of the trust-based personalized offer portal will then analyze the response to confirm its validity in order to allow the session to continue. This key delivery and capture routine—spoken 550 is incorporated by reference in the embodiments depicted in FIG. 16 and FIG. 17.

Another aspect of the multi-phased biometric security schema 500 as depicted in FIG. 11 is the key delivery and capture routine—visual 560, which is connected to the secure session servers 165 at access point 506. In this routine, an encrypted, user-facing token is generated by the security and biometric server 184 at the establishment of a session created by the secure session server 165.

Once the encrypted, user-facing token is generated by the security and biometric server 184 it is then passed on to the secure session server 165 and then used to establish the validity of the session by challenging the user for a “read-back” of the an encrypted, user-facing token once it is rendered at the user terminal device. Such a user-facing token may be transmitted directly to the user's terminal device, or it may sent to an alternate device via SMS or email message, by example. This visual challenge may be sent to the device via the session control, voice gateway, SMS, chat, email gateway 10. Likewise, the visual challenge may be sent to the alternate device mentioned above by the session control, voice gateway, SMS, chat, email gateway 10. The user will then respond to the challenge of this visual user-facing token by repeating it back to the system, typically by typing a keyboard-type response or using buttons on a remote control, depending upon the particular user device being handled by the user. The media server, speech and biometric token handling, secure data handling 20 element of the trust-based personalized offer portal will then analyze the response to confirm its validity in order to allow the session to continue.

Another aspect of the multi-phased biometric security schema 500 as depicted in the embodiment of FIG. 11 is the biometric enrollment routine 570. The biometric enrollment routine 570 is connected to the security and biometric server 184 at access point 507. In this routine, a pre-supplied enrollment number or personal identification number (PIN) is employed by the user to start the session. At this point, a temporary secure session key is generated by the security and biometric server 184 at the establishment of a session created by the secure session server 165. The user is then prompted to speak a unique word that is then associated with the user's voice and then stored as an encrypted biometric token security and biometric encryption database 195. In subsequent sessions, this encrypted biometric token will be used to compare with subsequent utterances as part of the aforementioned biometric evocation routine 530. The dialog in which the user as solicited for a spoken biometric sample, which is captured by the system and stored as a token, may be via the session control, voice gateway, SMS, chat, email gateway 1.

Another aspect of the multi-phased biometric security schema 500 as depicted in FIG. 11 is the secure data capture routine 580. The secure data capture routine 580 is connected logically to the security and biometric server 184 at access point 508. In this routine, the regular input supplied by the user is encrypted for transmission and also stored as encrypted data in the transaction history 197 or the security and biometric encryption database 195. Depending on the data to be encrypted and the user device employed, this secure data capture routine 580 is dependent upon the secure session servers 165 and the security and biometric server 184 to use certain data and instructions stored in the database. For example, offer configuration server 181 has access to the vendor and offer scripts database 192 and will supply the secure session servers 165 and the security and biometric server 184 with the appropriate instructions for encrypting data from sessions established via the offer configuration server 181 dealing with offer dialogs whether they be verbal dialogs or visual ones. For example, the vendor and offer scripts database 192 will be accessed by offer configuration server 181 to supply the secure session servers 165 and the security and biometric server 184 with the appropriate instructions for encrypting data from sessions established via the offer configuration server 181 dealing with vendor offers.

With reference to FIG. 12, one embodiment for the creation of the persona corral for customer service oriented transactions contemplates primarily using the common user interface. This is called common user interface creation of persona corral—logic flow. The creation of the persona corral by the customer acts as an offer enrollment system, where the customer will stipulate what his preferences are for commercial offers, amongst other attributes.

At step 1000, the user is presented with the persona creation and editing menu. Such menu may be presented verbally as per an interactive voice response (IVR) dialog, or it may be presented in a graphical user interface (GUI) means as appropriate for the particular user device employed. As described above with reference to FIG. 10, rhe user interface aggregator matrix 900 architecture may be used to establish a common means to present data to users. Such is the case with the presentation of menu selections and session establishment described here.

At decision branch 1005, the user is asked to choose between a screen-based versus a telephone based approach to the creation of the persona corral. If the user chooses a telephone-based approach, the process continues to step 1100, further detailed in FIG. 13. If the user chooses a screen-based approach the logic flow continues to decision branch 1007.

At decision branch 1007, the system establishes whether or not the user has already enrolled in the system by using the biometric enrollment routine 570 as explained above. If the user has not enrolled he is directed to enroll as per step 1200 specifically illustrated in FIG. 14 and set forth below. If the user has already enrolled the logic flow continues to step 1300, where the two-phased security routine begins.

At decision branch 1009, the determination of pass or fail of the security two-phased security routine 1300 is made. If the user fails to pass the routine, he is offered standard error recovery methods. If standard error recovery methods fail, the user is refused further access to the application. If the user passes the two-phased security routine 1300, the logic flow continues to step 1011, where the user is asked to select a persona icon or persona avatar from the screen. The visual attributes of the persona are not contemplated in the scope of the invention. Instead, the varied financial, personal, and social attributes of the Persona are in the scope of the invention. A plurality of personas' each with different attributes may be created. For example, icons representing a sports-oriented persona may manifest in a basketball or baseball, whereas icons representing a commercial inquiry for a bank balance may manifest in a dollar sign insignia.

At decision branch 1013, the user is asked to select another persona or to continue with the definitions of the one first chosen. If the user chooses another persona, he will be directed to step 1011. Otherwise, the logic flow continues to step 1015. Here, the user selects a name for the persona. This name is verified and then saved in the persona resources library and database 198.

At step 1017, the user selects a vendor from a list to be associated with this persona. This vendor attribute is verified and then saved in the persona resources library and database 198.

Then, at step 1019, the user inputs offer preferences associated with the selected vendor and so it is associated also with this persona. These offer preferences may include, but are not limited to the types of products the customer is interested in. These attributes are then verified and saved in the persona resources library and database 198.

At step 1021, the user inputs parameters dealing with their tolerance level for the Frequency and time frames of certain offers. For example, the customer may indicate he only wants one offer a day or one offer a week from this vendor and further may stipulate the offers should only be tendered during certain hours of the day. The level of granularity and detail in these time-varying parameters have no limit and the invention is not constrained by the suggestions listed here. These time-varying and frequency based attributes are then verified and then saved in the persona resources library and database 198.

At step 1025, the user inputs additional attributes associated with the selected vendor and so it is associated also with this persona. For example, the customer may stipulate that this persona is a constant use persona by choosing a one-way offer path from the vendor to the customer for “canned” offers that many customers may receive. In another aspect of the invention, the customer may stipulate that this persona is an ad-hoc or “throw away” persona that is to be used for creating and initiating a reverse auction wherein several vendors may log in to the trust-based personalized offer portal to bid on a specific offer request initiated by the customer. In this aspect of the invention, the customer uses the parameter-based selection in the creation of the persona corral to invent a specific persona for this reverse auction. For example, the customer may stipulate the following attributes although these are not meant to limit the number of attributes: a) The type of product he is interested in receiving a custom bid for; b) The price range to be contemplated for purchase of the item; c) The time frame in which the decision to buy will be made; d) the breadth of involvement from other vendors (such breadth of involvement from other vendors may be tagged as a “throw-away” or one-time attribute to allow vendors who are not usually preferred to participate); e) the permission for vendors to contact the customer directly based on a specific media preference such as chat, for example.

These additional attributes are verified and then saved in the persona resources library and database 198. A variety of attributes may be solicited from the user as it relates to each vendor. This is in keeping with the type of data that may need to be used in offer scripts dialogs via “verbal” offers using the IVR (interactive voice response) capability of the trust-based personalized offer portal. This is determined when the service creation and provisioning server 183 is used to create vendor-specific vendor and offer scripts which are then stored in the vendor and offer scripts and library 192 database. Part of the creation of an offer script is the identification of key value pairs and variables that will be stored on behalf of each customer as they are associated with that vendor. For example, an offer script may have a placeholder for a “frequency of offers” input. Once captured here, the persona resources library and database 198 will provide the secure session servers 165 with the frequency tolerance attribute, which will then be offered to the offer configuration server 181 so it can be sure to not send any more offers than allowed by that threshold stipulated by the customer. These attributes at 1017, 1019, 1021, and 1025 clearly establish the customer's personal preferences and thus establish a trust or covenant with the operator of the trust-based personalized offer portal.

At decision branch 1027, the user is asked if he wishes to input additional attributes. For example, even though offers will typically be embodied as a non-pervasive item in a specific offer inbox, the size, loudness, and length of the offers may also be stipulated by the customer here under additional attributes. If he wishes to add additional attributes, he is directed back to step 1025. If he is done with attribute input, the logic flow continues to step 1030.

At step 1030, the user is asked to choose a preferred device for the delivery off offers. Such a device may be singular or there may be a plurality of devices. If the customer is creating an ad-hoc persona for use in a reverse auction, the vendor will have access to the customer-preferred devices in the service creation and provisioning server 183.

At decision branch 1032, the user is asked if he wishes to input more devices. If he wishes to add an additional device, he is directed back to step 1030. If he is done with attribute input, the logic flow continues to decision branch 1035, where the user is asked if he wishes to input data for more vendors. If he wishes to add additional vendors, he is directed back to step 1017. If he is done with vendor input, the logic flow continues to decision branch 1037. At decision branch 1037, the user is asked if he wishes to input data for more personas. If he wishes to add additional personas, he is directed back to step 1011. If he is done with persona input, the logic flow continues to step 1040, in which the system synchronizes the data collected from the user. This data is stored in the appropriate databases and also distributed in real time to the affected servers so the most recent user selects may be put to use immediately. The common user interface creation of persona corral—logic flow 1000 terminates at this point as the user is returned to 1000, which is the persona creation and editing main menu.

FIG. 13 describes the logic flow for the creation of the persona corral for customer service oriented transactions, primarily using the telephone or speech device. This is called common user interface creation of persona corral logic flow 1000.

At step 1100, the user is presented with the persona creation and editing menu for telephone or speech device. In one embodiment of the invention the menu is presented verbally as per an interactive voice response (IVR) dialog. Alternately, it can be used to present abbreviated SMS-type menu prompts or abbreviated soft-key prompts for VoIP soft phones or VoIP physical phones. FIG. 10 describes how the user interface aggregator matrix 900 architecture may be used to establish a common means to present data to users. In particular this persona creation and editing menu for telephone or speech device can be made to work with a smart phone environment 322 as described in FIG. 7, or it can be made to work in a VoIP software-based telephone environment 344, as described above with reference to FIG. 8. In this aspect of the invention, the presentation of menu selections and session establishment described here may be achieved over the phone in an IVR-type dialog.

At decision branch 1107, the system establishes whether or not the user has already enrolled in the system by using the biometric enrollment routine 570. If the user has not enrolled it is directed to enroll as per the logic flow presented in FIG. 14. If the user has already enrolled the logic flow continues to step 1300, where the two-phased security routine 1300 begins. At decision branch 1109, the determination of pass or fail of the security two-phased security routine 1300 is made. If the user fails to pass the routine, he is offered standard error recovery methods. If standard error recovery methods fail, the user is refused further access to the application. If the user passes the two-phased security routine 1300, the logic flow continues to step 1111. At this point, the user is asked to select an IVR speech response or an embedded device-oriented speech response.

At decision branch 1113, the user is asked to confirm the speech mode selection. If the user wants to change it, he is directed to step 1111, otherwise, the logic flow continues to step 1115, where the user selects a name for the persona. This selection is provided either with the user's spoken input or with touch-tones. This name is verified and then saved in the persona resources library and database 198.

At step 1117, the user selects a vendor from a list to be associated with this persona. This selection is provided either with the user's spoken input or with touch-tones. This vendor attribute is verified and then saved in the persona resources library and database 198.

At step 1119, the user inputs a offer preferences associated with the selected vendor and so it is associated also with this persona. This selection is provided either with the user's spoken input or with touch-tones. These offer preferences may include, but are not limited to the types of products the customer is interested in. these attributes are then verified and saved in the persona resources library and database 198.

Then, at step 1121, the user inputs parameters dealing with their tolerance level for the frequency and time frames of certain offers. This input is provided either with the user's spoken input or with touch-tones. For example, the customer may indicate he only wants one offer a day or one offer a week from this vendor and further may stipulate the offers should only be tendered during certain hours of the day. The level of granularity and detail in these time-varying parameters have no limit and the invention is not constrained by the suggestions listed here. These time-varying and frequency based attributes are then verified and then saved in the persona resources library and database 198.

At step 1125, the user inputs additional attributes associated with the selected vendor and so it is associated also with this persona. This input is provided either with the user's spoken input or with touch-tones. For example, the customer may stipulate that this persona is a constant use persona by choosing a one-way offer path from the vendor to the customer for “canned” offers that many customers may receive. In another aspect of the invention, the customer may stipulate that this persona is an ad-hoc or “throw away” persona that is to be used for creating and initiating a reverse auction wherein several vendors may log in to the trust-based personalized offer portal to bid on a specific offer request initiated by the customer. In this aspect of the invention, the customer uses the parameter-based selection in the creation of the persona corral to invent a specific persona for this reverse auction. For example, the customer may stipulate the following attributes although these are not meant to limit the number of attributes: a) the type of product he is interested in receiving a custom bid for; b) the price range to be contemplated for purchase of the item; c) the time frame in which the decision to buy will be made; d) the breadth of involvement from other vendors (such breadth of involvement from other vendors may be tagged as a “throw-away” or one-time attribute to allow vendors who are not usually preferred to participate); e) the permission for vendors to contact the customer directly based on a specific media preference such as chat, for example.

These additional attributes are verified and then saved in the persona resources library and database 198. A variety of attributes may be solicited from the user as it relates to each vendor. This is in keeping with the type of data that may need to be used in offer scripts dialogs via “verbal” offers using the IVR (interactive voice response) capability of the trust-based personalized offer portal. This is determined when the service creation and provisioning server 183 is used to create vendor-specific vendor and offer scripts which are then stored in the vendor and offer scripts and library 192 database. Part of the creation of an offer script is the identification of key value pairs and variables that will be stored on behalf of each customer as they are associated with that vendor. For example, an offer script may have a placeholder for a “frequency of offers” input. Once captured here, the persona resources library and database 198 will provide the secure session servers 165 with the frequency tolerance attribute, which will then be offered to the offer configuration server 181 so it can be sure to not send any more offers than allowed by that threshold stipulated by the customer. These attributes received at decision branches 1017, 1019, 1021, and 1025 clearly establish the customer's personal preferences and thus establish a trust or covenant with the operator of the trust-based personalized offer portal.

At decision branch 1127, the user is asked if he wishes to input additional attributes. This input is provided either with the user's spoken input or with touch-tones. For example, even though offers will typically be embodied as a non-pervasive item in a specific offer inbox, the size, loudness, and length of the offers may also be stipulated by the customer here under additional attributes. If he wishes to add additional attributes, he is directed back to step 1125. If he is done with attribute input, the logic flow continues to step 1130.

At step 1130 the user is asked to choose a preferred device for the delivery of offers. This input is provided either with the user's spoken input or with touch-tones. Such a device may be singular or there may be a plurality of devices. If the customer is creating an ad-hoc persona for use in a reverse auction, the vendor will have access to the customer-preferred devices in the service creation and provisioning server 183.

At decision branch 1132, the user is asked if he wishes to input more devices. This input is provided either with the user's spoken input or with touch-tones. If he wishes to add an additional device, he is directed back to step 1130. If he is done with attribute input, the logic flow continues to decision branch 1135, where the user is asked if he wishes to input data for more vendors. This selection is provided either with the user's spoken input or with touch-tones. If he wishes to add additional vendors, he is directed back to step 1117. If he is done with vendor input, the logic flow continues to decision branch 1137.

At decision branch 1137, the user is asked if he wishes to input data for more personas. This selection is provided either with the user's spoken input or with touch-tones. If he wishes to add additional personas, he is directed back to step 1115. If he is done with persona input, the logic flow continues to step 114, where the system synchronizes the data collected from the user. This data is stored in the appropriate databases and also distributed in real time to the affected servers so the most recent user selects may be put to use immediately. The common user interface creation of personal corral logic flow—telephone or speech device 1100 terminates at this point as the user is returned to the persona creation and editing main menu for telephone or speech device.

FIG. 14 is a flowchart illustrating the security enrollment routine for the embedded speech device. This is called security enrollment—embedded speech device 1200. At step 1200, the embedded speech security enrollment starts, and at 1205, the user is prompted to enroll by responding with a speech command based on a verbal menu. This menu is designed primarily to be presented verbally as per an interactive voice response (IVR) dialog. Alternately, it can be used to present abbreviated SMS-type menu prompts or abbreviated soft-key prompts for VoIP soft phones or VoIP physical phones. As set forth above, the user interface aggregator matrix 900 architecture may be used to establish a common means to present data to users. In particular, this persona creation and editing menu for an embedded speech device can be made to work with a smart phone environment 322, or it can be made to work in a VoIP software-based telephone environment 344. In this aspect of the invention, the presentation of menu selections and session establishment described here is achieved primarily over the phone in an IVR-type dialog. In one aspect of the invention, such speech-based prompts may be uttered and also collected and processed by an embedded speech device associated with the terminal device itself. This may include, but is not limited to an embedded speech device attached to a multimedia/TV set top box 360, or a smart phone 320, or a speech-enabled PC running a web browser 300.

At decision branch 1209, the system will present the user with a prompt asking for the user to verbally enunciate a challenge word or phrase. In one embodiment of the invention, this challenge word or phrase will have been randomly chosen. Such a challenge word will be generated by the system using random phrase generator based on a pre-programmed corpus of recorded phonemes or whole words. These utterances are stored in the security and biometric encryption database 195. Likewise, after the user responds, the user-uttered phrase will be stored in the security and biometric encryption database 195 for later comparison when the user is subsequently challenged to start subsequent sessions. These comparisons will be governed based on the session established by the secure session servers 165. The establishment of a secure session is the multi-phased biometric security schema 500.

Also at decision branch 1209, the system will provide an alternative for providing the prompt asking for the challenge word or phrase. In one case, the system will announce the challenge word or phrase verbally as in step 1211 and in another case, the system will provide a screen-based presentation of the same word or phrase as in step 1215.

At decision branch 1213, the system will ask the user to choose if they want the challenge word or phrase to be presented via an SMS message to the user's registered SMS device, or whether the user wants the challenge word or phrase to be presented via the native user interface of the particular device that is registered for that user. The terminal device protocol server 189 holds the particular protocols and methods for delivering such information to the user, and these terminal device data are also stored in the terminal device database 191. If the user chose an SMS message the system will send the SMS to the registered device as per step 1215. If the user chooses for the delivery method to be via the native screen of the user device, the challenge word or phrase will be presented on the native device.

At step 1217, regardless as to the presentation method chosen by the user, the user will respond with spoken confirmation on the presented challenge word or phrase provided by the system. Then, at step 1220, the biometric token thus collected from the user will be sent to the security and biometric server 189 and follow the protocol called the multi-phased biometric security schema 500. At step 1222, the biometric token will be stored in the security and biometric encryption database 195 for later comparison when the user is subsequently challenged to start subsequent sessions. At step 1225, the system confirms the successful capture of the biometric token by prompting for it to be spoken again, this time verifying the process by doing the aforementioned comparison called the multi-phased biometric security schema 500.

At decision branch 1227, the system provides an error recovery routine to determine if the user forgot the word if the utterance did not properly compare to the stored biometric token. If there is a failure, the user will return to step 1200 to re-enroll. If the comparison is a success, the logic flow continues to step 1229, where, as part of the error recovery routine, the user is asked by the system to repeat the challenge word or phrase. Then, at step 1230, as part of the error recovery routine, the user speaks the challenge word or phrase.

At decision branch 1233, the system verifies the success of the routine. If the system confirms the successful capture of the biometric token, the enrollment is complete, otherwise the verification process repeats at step 1225 or aborts based on the implementation preference of the practitioner.

FIG. 15 is a flowchart illustrating the security enrollment routine for the telephone-based device. This is called security enrollment—telephone-based device 1250, which is the starting point of the telephone-based security enrollment. At step 1255, the user is prompted to enroll by responding with a speech command based on a verbal menu presented verbally as an interactive voice response (IVR) dialog. Alternately, it can be used to present abbreviated SMS-type menu prompts or abbreviated soft-key prompts for VoIP soft phones or VoIP physical phones. As mentioned above with reference to FIG. 10, the user interface aggregator matrix 900 architecture may be used to establish a common means to present data to users. In particular, this persona creation and editing menu for a telephone-based device can be made to work with a smart phone environment 322, or it can be made to work in a VoIP software-based telephone environment 344. In this aspect of the invention, the presentation of menu selections and session establishment described here is achieved primarily over the phone in an IVR-type dialog. The terminal devices that may be used for the user to have an IVR-based telephone dialog may include, but is not limited to a telephone 340 (including a regular PSTN telephone or VoIP telephone), a smart phone 320, or a web browser 300 equipped with a VoIP soft phone.

At decision branch 1259 the system will present the user with a choice of having the challenge word verbally enunciated over the phone or alternately sent to a registered SMS device. If the user chooses the SMS device, the challenge word or phrase will be transmitted via SMS as per step 1261, otherwise it will be spoken via voice prompt over the phone. In a one embodiment of the invention, this challenge word or phrase will have been randomly chosen. Such a challenge word will be generated by the system using random phrase generator based on a pre-programmed corpus of recorded phonemes or whole words. These utterances are stored in the security and biometric encryption database 195. The terminal device protocol server 189 holds the particular protocols and methods for delivering such information to the user, and these terminal device data are also stored in the terminal device database 191.

At step 1263, regardless as to the presentation method chosen by the user, the user will respond with spoken confirmation on the presented challenge word or phrase provided by the system. Then, at step 1270, the biometric token thus collected from the user will be sent to the security and biometric server 189 and follow the protocol described above called the multi-phased biometric security schema 500. At step 1272, the biometric token will be stored in the security and biometric encryption database 195 for later comparison when the user is subsequently challenged to start subsequent sessions. Then, at step 1275, the system confirms the successful capture of the biometric token by prompting for it to be spoken again, this time verifying the process by doing the aforementioned comparison that is described with reference to FIG. 11 called the multi-phased biometric security schema 500.

At decision branch 1277, the system provides an error recovery routine to determine if the user forgot the word if the utterance did not properly compare to the stored biometric token. If there is a failure, the user will return to step 1250 to re-enroll. If the comparison is a success, the logic flow continues to step 1279, where, as part of the error recovery routine, the user is asked by the system to repeat the challenge word or phrase. At step 1280, as part of the error recovery routine, the user speaks the challenge word or phrase.

At decision branch 1283, the system verifies the success of the routine. If the system confirms the successful capture of the biometric token, the enrollment is complete, otherwise the verification process repeats at step 1275 or aborts based on the implementation preference of the practitioner.

The flowchart of FIG. 16 describes the two-phased security routine for the embedded speech device. This is called two-phased security routine—embedded speech device 1300. At step 1305, the system will challenge the user to speak the stored word or phrase associated with the biometric key produced from the security enrollment routine described above. At step 1307, the user speaks the word or phrase. Then, at step 1309, the biometric token thus collected from the user will be sent to the security and biometric server 189 and follow the protocol described above with reference to FIG. 11 called the multi-phased biometric security schema 500.

At decision branch 1311, the system confirms the successful capture of the biometric token. If the routine fails, the system prompts the user to retry as in step 1305, otherwise the logic flow continues to step 1315, where the system goes into the second phase of the two-phased security routine in which a secure session key is generated and presented to the user. This is done using the protocols outlined in the session-specific key generation routine 540.

At decision branch 1317, the system will provide an alternative for presenting the secure session key token. In one case, the system will present the token for the secure session key as per the native capabilities of the embedded speech device registered to the user as per step 1321. The terminal device protocol server 189 holds the particular protocols and methods for delivering such information to the user and these terminal device data are also stored in the terminal device database 191. In another case, the system will present the token for the secure session key via an SMS message to the user's registered SMS device as per step 1319. At step 1325, regardless as to the presentation method chosen by the user, the user will respond with spoken confirmation on the presented token provided by the system.

At decision branch 1327, the system confirms the successful capture and verification of the token for the secure session key. If the token is verified the security routine is complete, otherwise the logic flow continues to decision branch 1330.

At decision branch 1330, the system provides an error recovery routine to determine if the user forgot the word if the utterance did not properly compare to the automatically generated secure session key. If the user forgot the word, he will be returned to step 1315 for the key to be resent. If the user did not forget the word but the verification nonetheless failed, the logic flow continues to step 1331, where, as part of the error recovery routine, the user challenged once again to repeat the word or phrase to compare to the secure session key. Then, at step 1333, as part of the error recovery routine, the user speaks the word or phrase again.

At decision branch 1335, the system verifies the success of the routine. If the system confirms the successful capture of the biometric token, the enrollment is complete, otherwise the verification process repeats at step 1331 or aborts based on the implementation preference of the practitioner.

The flowchart of FIG. 17 describes the two-phased security routine for the telephone-based device. The routine begins at step 1350, and at step 1355, the system will challenge the user to speak the stored word or phrase associated with the biometric key produced from the security enrollment routine. Then, at step 1357, the user speaks the word or phrase. At step 1359, the biometric token thus collected from the user will be sent to the security and biometric server 189 and follow the protocol described above with reference to FIG. 11 called the multi-phased biometric security schema 500.

At decision branch 1361, the system confirms the successful capture of the biometric token. If the routine fails, the system prompts the user to retry as in step 1355, otherwise the logic flow continues to step 1365, where the system goes into the second phase of the two-phased security routine in which a secure session key is generated and presented to the user. This is done using the protocols outlined in the session-specific key generation routine 540 mentioned above.

At decision branch 1367, the system will provide an alternative for presenting the secure session key token. In one case, the system will present the token for the secure session key via a speech prompt as in a regular interactive voice response (IVR) dialog as per 1371. The terminal device protocol server 189 holds the particular protocols and methods for delivering such information to the user and these terminal device data are also stored in the terminal device database 191. In another case, the system will present the token for the secure session key via an SMS message to the user's registered SMS device as per step 1369. At step 1375, regardless as to the presentation method chosen by the user, the user will respond with spoken confirmation on the presented token provided by the system.

Then, at decision branch 1377, the system confirms the successful capture and verification of the token for the secure session key. If the token is verified, the security routine is complete, otherwise the logic flow continues to a decision branch 1380.

At decision branch 1380, the system provides an error recovery routine to determine if the user forgot the word if the utterance did not properly compare to the automatically generated secure session key. If the user forgot the word, he will be returned to step 1365 for the key to be resent. If the user did not forget the word but the verification nonetheless failed, the logic continues to step 1381, where, as part of the error recovery routine, the user challenged once again to repeat the word or phrase to compare to the secure session key. At step 1383, as part of the error recovery routine, the user speaks the word or phrase again.

At decision branch 1385, the system verifies the success of the routine. If the system confirms the successful capture of the biometric token, the enrollment is complete, otherwise the verification process repeats at step 1381 or aborts based on the implementation preference of the practitioner.

The flowchart of FIG. 18 depicts the logic flow for configuring offers by a vendor. This is called vendor use of offer configuration—logic flow 1400. At decision branch 1401, the user chooses between partaking in the biometric security routine via an embedded speech device or via a telephone. If the user chooses telephone, the routine described above with reference to FIG. 17 called two-phased security routine—telephone 1350 is used, otherwise, the routine described above with reference to FIG. 16 called two-phased security routine—embedded speech device 1300 is used.

The customer service routine continues at step 1403, when the user selects a particular persona icon or avatar based on the precepts of the common user interface aggregator matrix 900 architecture as described above with reference to FIG. 10. Once the persona is selected, the user associates the persona with the icon representing the vendor in question. The practitioner will note that the association of a persona with more than one vendor is allowed. For example, if the customer imbued the chosen persona with ad-hoc or “throw away” attributes, it may be used as a trigger for initiating a reverse auction, wherein the customer solicits bids from one or more vendors for a product or service the customer is interested in. None of the routines possible should be limited in scope by way of the example set forth in the figures.

At step 1405, the requisite encrypted session key and security procedures are performed by the secure session servers 165 and the security and biometric server 184 as described in the multi-phased biometric security schema 500 described above with reference to FIG. 11.

At step 1407, the system asks the vendor to choose between a delivering a specific offer campaign via a “verbal” offer such as in a interactive voice response (IVR) dialog, or a web-based offer which will manifest itself based on a connection to the user interface aggregator matrix 900. If by the user interface aggregator matrix 900, offers will be delivered to the customer's “offer inbox” either on the web browser 300, smart pone 320, telephone 340, or multimedia/TV set-top box 360. In another aspect of the invention, and if authorized by the customer, the vendor and customer may have a chat dialog if the customer wishes to respond to a vendor's offer. In such a dialog, the trust-based personalized offer portal will host a chat between the vendor and the customer. Such a dialog will be supported as per the capabilities described in previously with reference to FIG. 2 which deal with the session control, voice gateway, SMS, chat, email gateway 10 entity. In addition to chat, the trust-based personalized offer portal has the ability to support the protocols required to communicate via other media such as telephone, email and SMS, by way of example.

These vendors' use of the offer configuration server 181 allows certain data to be stored in the vendor and offer scripts database. The offer scripts are loaded into and executed on by a variety of servers in the trust-based personalized offer portal. For example, the secure session servers 165 manage the overall session management, set up and tear down of sessions and the handling of security on those sessions along with the security and biometric server 184. For example, the vendor and offer scripts database 192 and the offer configuration server 181, both depicted in FIG. 4 and FIG. 5, respectively, work together with the secure session servers 165 to determine what offer scripts and what dialogs need to be executed on in a particular offer campaign. Such an offer campaign will trigger the transmission of an offer to a customer's offer inbox as described above.

At the level of the individual offer configuration server 181, the script instructions are broken down into individual commands that are fed to the secure session servers 165 to initiate an offer session. What scripts are used depends on what vendor is chosen by the user when the user associates a persona from the persona corral with a vendor icon using the user interface aggregator matrix 900.

In another aspect of the invention, offer script instructions from the offer configuration server 181 may be implemented by the practitioner in a hybrid fashion. For example, as per decision branch 1407, the vendor may opt for a voice-based offer. But even if the offer itself is initiated by voice the customer may wish to respond to the offer via a call back mechanism. For example, it is not uncommon for web sites to have web-based callback technology installed so users can type in their phone number which then triggers a live phone call back to the customer. Still other web sites may use voice over internet protocol (VoIP) technology which allows customers to establish a live phone call using the web as the carriage for the call with an associated VoIP phone instead of the traditional public switched telephone network. The invention contemplates these scenarios as they can be robotically automated on behalf of customers using the aforementioned vendor and offer scripts outlined here. The practitioner will find myriad approaches to connect customers with vendors' web sites, contact centers and IVR systems utilizing the invention. None of these examples here will be at the exclusion of other possible communications modes with the use of automated offer scripts can be implemented.

At step 1410, based on the selection of a “verbal offer” via an IVR mechanism, the appropriate vendor and offer scripts are loaded in the offer configuration server 181. At step 1415, based on the selection of a “visual offer” via a native device or web-type dialog, the appropriate vendor and offer scripts are loaded in the offer configuration server 181. At step 1417, the vendor is asked to either select or upload an icon or sound file to associate with the offer. Such a media file may be stored on the media storage 194 database.

At step 1420, the offer configuration server 181 establishes a secure session on behalf of the vendor to ensure the offer campaign he is creating is encrypted properly. This may include, but is not limited to the secure passing of vendor account numbers and PIN numbers to facilitate payment to the operator of the trust-based personalized offer portal for the purposes of collecting a fee for the distribution of offers. Such financial data will have been collected from the vendor in a previous secure session or entered by the administrator using the service creation provisioning server 183.

At step 1425, the vendor is presented with menu selections to name the offer for this specific campaign. The name of the offer campaign is used for tracking and reporting on the campaign and will be stored along with other data associated with the campaign in the vendor and offer scripts database 192. The vendor will also have the option of copying a stored offer campaign and then assigning a new name to it. Once the name of the offer campaign is established, the vendor will be prompted to upload a graphic, sound file, video and text associated with the offer. Thus, it is contemplated that limits or other constraints may be set on the offer. Here, the practitioner will be familiar with standard programs and tools for uploading media, and how file size restrictions and character length restrictions can be accounted for. The invention contemplated providing a trust or covenant-based agreement between the operator of the trust-based personalized offer portal and the customer. Even though the offers will typically be embodied as a non-pervasive item in a specific offer inbox, the size, loudness, and length of the offers may also be stipulated by the customer.

At step 1427, the offer configuration server 181 will provide the vendor with choices on the volumes of offer slots that are available for sale. At step 1430, the time frames chosen will be input by the vendor and at step 1432, the vendor decides on the frequency of the offer. The offer configuration server 181 will then provide a price to pay for the offer campaign based on these parameters. A price for an offer slot may be dynamically established. An offer slot is a unique, personalized offer that will be tendered to a customer who has authorized offers from that vendor. As the practitioner will realize, the number of offer slots available cannot exceed the sum of the allowed offers by the collective customers served by the trust-based personalized offer portal during any particular time period. This “throttling” of the offers allowed for sale is based on the persona resources library and database 198 where the parameters of personas, selected by the customers, are stored. The report generation server 186 will automatically collect the appropriate “throttling” data from the database and send this information to the offer configuration server 181 during an offer campaign creation. Once this data is collected—based on the peculiar inputs by the vendor during this session, the rates for the offer campaign may be calculated and presented to the vendor. The practitioner will realize that the establishment of rates will be tied to the perceived premium for limited offer slots and of course the availability of certain time frames and frequencies allowed collectively by customers. This aspect of the invention establishes that the rates for advertising (that is allowing the offers to be posted) may be dynamic.

At step 1434, the offer configuration server 181 will provide the vendor with an option to set the expiry timer for the offer campaign. The expiry timer is a parameter that determines how long the offer will “live” in the customer's offer inbox before the offer is withdrawn and is no longer valid. The life length of an offer may be used to establish a premium rate because the offer may get multiple exposures to customers who often browse their offer inbox multiple times and may view the same offer more than once. The vendor may wish to throttle the life length of offers for commercial reasons such as availability. In this aspect of the invention, the vendor may use extremely short expiry timers to reduce inventory.

At step 1436, the offer configuration server 181 will provide the vendor with options to add demographic parameters. These demographic parameters act as a means to further restrict or qualify the offer campaign. For example, demographic parameters may include but are not limited to: a) the age range of the intended audience; b) the frequency of log-ons to the trust-based personalized offer portal; c) the preferred terminal (user) device of the customers; d) the preference or non-preference for certain types of products; e) the preference of time frames and frequencies for offers, f) live in a certain area, and so on. In one embodiment of the invention, the vendor could target an offer campaign to only reach customers who log on once a day, and who prefer offers dealing with automobiles, and who live in Las Vegas. In fact, the vendor may have an offer that is not related to automobiles per se, but may be a hotel package within driving distance of Las Vegas for those customers.

At decision branch 1438, the vendor will be prompted for any changes to be made in the offer campaign. If the vendor wishes to make changes, he is directed to step 1427. Otherwise, the logic flow continues to step 1440, where the newly created parameters and options made by the vendor in the offer configuration logic flow are saved in the appropriate databases and the session ends.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A portal system for managing communications between a vendor and a plurality of customers comprising:
a network gateway connectible to a customer device over a telecommunications link;
an offer configuration server connected to the network gateway and processing one or more executable offer scripts for the vendor, the offer scripts generating an offer communication targeted to one or more of the customers according to receive settings defined each of the one or more of the customers and delivery settings defined by the vendor; and
an offer database associated with the offer configuration server, the offer scripts being stored on the offer database;
wherein the offer scripts includes a verbal offer component and a visual offer component.

2. The system of claim 1, wherein the offer communications are transmitted to the user device in real-time.

3. The system of claim 1, wherein the offer communications are transmitted to the user device in non real-time.

4. The system of claim 1, wherein the offer is selected from a group consisting of advertisements, offers for sale, reverse auctions, and coupon redemptions.

5. The system of claim 1, wherein the delivery settings include time-varying parameters affecting the rate of transmitting of the offer communications.

6. The system of claim 1, wherein the delivery settings include volume parameters affecting the number of transmitting of the offer communications.

7. The system of claim 1, wherein the delivery settings include demographics parameters defining the specific customers to which the offer communications are transmitted.

8. The system of claim 1, wherein one or more identical receive settings of a plurality of customers defines an offer slot.

9. The system of claim 8, wherein a price is assigned to the offer slot, an offer communication to the customers in the offer slot being transmittable upon payment of the price.

10. The system of claim 1, further comprising:
a profile associated with each of the one or more of the customers, the profiles being defined by one or more personas each including the receive settings;
wherein the receive settings is selected from a group consisting of product preferences, vendor preferences, offer frequency preferences, and offer volume preferences.

11. The system of claim 1, wherein the verbal offer component is based off an interactive voice response system.

12. The system of claim 1, further comprising:
a native system delivery module in communication with the offer configuration server, the visual offer component being translated thereby to a form specific to the customer device.

13. The system of claim 12, wherein the visual offer component includes data deliverable to an electronic mail account.

14. The system of claim 12, wherein the visual offer component includes data deliverable to a web browser.

15. The system of claim 10, further comprising:
a security module connected to the network gateway and the reverse automation subsystem, access to the offer scripts being restricted thereby prior to authentication by the customer.

16. The system of claim 15, wherein the authentication includes transmitting a biometric identifier from the user device to the security module.

17. The system of claim 1, further comprising:
a media server connected to the offer configuration server, the media server including one or more multimedia content transferrable to the customer device for playback thereon as part of the offer communications.

18. The system of claim 17, wherein the multimedia content is selected from a group consisting of: text, images, sound, and video.

19. The system of claim 1, wherein one of the telecommunications links is selected from a group consisting of: a public switched telephone network (PTSN), and an Internet Protocol (IP) network.

20. The system of claim 1, wherein the customer device is selected from a group consisting of: a web browser, a smart phone, a telephone, a Voice over IP-based telephone, and a set-top television box.
